(19) United States
(12) Patent Application Publication
(10) Pub. No.: US 2022/0058665 A1
(43) Pub. Date: Feb. 24, 2022

(54) METHODS AND APPARATUS TO ASSIGN DEMOGRAPHIC DISTRIBUTION DATA TO DIGITAL TELEVISION RATINGS (DTVR)

(71) Applicant: The Nielsen Company (US), LLC, New York, NY (US)

(72) Inventors: David J. Kurzynski, South Elgin, IL (US); Arseny Egorov, Sparks, NV (US); Mohammadjavad Pakdel, Irvine, CA (US); Jean Guerrettaz, Chicago, IL (US); Molly Poppie, Arlington Heights, IL (US)

(21) Appl. No.: 17/406,918

(22) Filed: Aug. 19, 2021

Related U.S. Application Data
(60) Provisional application No. 63/068,987, filed on Aug. 21, 2020.

(51) Int. Cl. G06Q 30/02; H04N 21/258

(52) U.S. Cl. CPC G06Q 30/0201; H04N 21/25883; G06Q 30/0204

(57) ABSTRACT

Methods, apparatus, systems, and articles of manufacture are disclosed to assign demographic distribution data to digital television ratings. An example apparatus includes factor generation circuitry to calculate a demographic adjustment factor based on digital probability distribution function (PDF) (digital-PDF) impressions and linear PDF (linear-PDF) impressions. The example factor generation circuitry is also configured to calculate a device adjustment factor based on historical calibrated demographic digital impressions and historical computed demographic digital impressions. The example apparatus further includes adjustment calculation circuitry to determine digital demographic impressions by applying the demographic adjustment factor to the current raw digital census impressions. The example adjustment calculation circuitry is also configured to determine digital device-demographic impressions by applying the device adjustment factor to the digital demographic impressions.

### CROSS-REFERENCE TO RELATED APPLICATION

This patent claims the benefit of and priority to U.S. Provisional Patent Application No. 63/068,987 filed Aug. 21, 2020, which is hereby incorporated herein by reference in its entirety.

### FIELD OF THE DISCLOSURE

This disclosure relates generally to computer-based media monitoring, and, more particularly, to methods and apparatus to assign demographic distribution data to digital television ratings (dTVR).

### BACKGROUND

Audience measurement entities (AMEs) collect audience measurement information from panelists (e.g., individuals who agree to be monitored by the AMEs) including the number of unique audience members for particular media and the number of impressions of the media corresponding to each of the audience members. In some examples, AMEs utilize third-party cookies (e.g., where the AMEs are third parties relative to the entity serving media to a client device) to collect audience measurement information. In such examples, an AME may issue an impression request to the entity serving the media to client devices. Third-party cookie tracking is used by measurement entities to track access to media by client devices from first-party media servers.

### BRIEF DESCRIPTION OF THE DRAWINGS

FIG. 1A illustrates an example communication flow diagram of an example manner in which an audience measurement entity (AME) can collect impressions and/or demographic information associated with audience members exposed to media.

FIG. 1B depicts an example system to collect impressions of media presented on mobile devices and to collect impression information from distributed database proprietors for associating with the collected impressions.

FIG. 2 is a block diagram of an example implementation of the dTVR control circuitry of FIGS. 1A and/or 1B to assign demographic distribution data to raw census impression data in accordance with teachings of this disclosure.

FIG. 3 is a data flow diagram illustrating an example data flow to assign demographic distribution data to digital television ratings data.

FIG. 4 is a data flow diagram illustrating an example data flow to calculate one or more demographic adjustment factors.

FIG. 5 is a data flow diagram illustrating an example data flow to calculate one or more device adjustment factors.

FIG. 6 is a flowchart representative of example machine readable instructions and/or operations that may be executed and/or instantiated by example processor circuitry to implement the dTVR controller of FIGS. 1A, 1B, and/or 2 to apply demographics to current raw digital census impressions.

FIG. 7 is a flowchart representative of example machine readable instructions and/or operations that may be executed and/or instantiated by example processor circuitry to implement the dTVR controller of FIGS. 1A, 1B, and/or 2 to assign demographic distribution data to raw census impression data.

FIG. 8 is a block diagram of an example processing platform including processor circuitry structured to execute and/or instantiate the example machine readable instructions and/or operations of FIG. 6 and/or the machine readable instructions and/or operations of FIG. 7.

FIG. 9 is a block diagram of an example implementation of the processor circuitry of FIG. 8.

FIG. 10 is a block diagram of another example implementation of the processor circuitry of FIG. 8.

FIG. 11 is a block diagram of an example software distribution platform (e.g., one or more servers) to distribute software (e.g., software corresponding to the example machine readable instructions and/or operations of FIGS. 6 and/or 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 12 is an example table illustrating raw digital census impression data.

FIGS. 13A and 13B are an example table describing example components set forth herein.

FIGS. 14A and 14B are tables illustrating example co-viewing impressions.

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Techniques for monitoring user access to an Internet-accessible media, such as digital television (DTV) media, have evolved significantly over the years. Internet-accessible media is also known as digital media. In the past, such monitoring was done primarily through server logs. In particular, media providers serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally, and then repeatedly accessed from the local cache without involving the server. Server logs cannot track such repeat views of cached media. Thus, server logs are susceptible to both over-counting and under-counting errors.

The inventions disclosed in Blumenau, U.S. Pat. No. 6,108,637, which is hereby incorporated herein by reference in its entirety, fundamentally changed the way Internet monitoring is performed and overcame the limitations of the server-side log monitoring techniques described above. For example, Blumenau disclosed a technique wherein Internet media to be tracked is tagged with monitoring instructions. In particular, monitoring instructions are associated with the hypertext markup language (HTML) of the media to be tracked. When a client requests the media, both the media and the monitoring instructions are downloaded to the client. The monitoring instructions are, thus, executed whenever the media is accessed, be it from a server or from a cache. Upon execution, the monitoring instructions cause the client to send or transmit monitoring information from the client to a content provider site. The monitoring information is indicative of the manner in which content was displayed.

In some implementations, an impression request or ping request can be used to send or transmit monitoring information by a client device using a network communication in the form of a hypertext transfer protocol (HTTP) request. In this manner, the impression request or ping request reports the occurrence of a media impression at the client device. For example, the impression request or ping request includes information to report access to a particular item of media (e.g., an advertisement, a webpage, an image, video, audio, etc.). In some examples, the impression request or ping request can also include a cookie previously set in the browser of the client device that may be used to identify a user that accessed the media. That is, impression requests or ping requests cause monitoring data reflecting information about an access to the media to be sent from the client device that downloaded the media to a monitoring entity and can provide a cookie to identify the client device and/or a user of the client device. In some examples, the monitoring entity is an audience measurement entity (AME) that did not provide the media to the client and who is a trusted (e.g., neutral) third party for providing accurate usage statistics (e.g., The Nielsen Company, LLC). Since the AME is a third party relative to the entity serving the media to the client device, the cookie sent to the AME in the impression request to report the occurrence of the media impression at the client device is a third-party cookie. Third-party cookie tracking is used by measurement entities to track access to media accessed by client devices from first-party media servers.

Monitoring information reported by a client device executing monitoring instructions does not provide an indication of the demographics or other user information associated with the person(s) that accessed the associated media. To at least partially address this issue, the AME establishes a panel of users who have agreed to provide their demographic information and to have their Internet browsing activities monitored. When an individual joins the panel, that person provides corresponding detailed information concerning the person's identity and demographics (e.g., gender, race, income, home location, occupation, etc.) to the AME. The AME sets a cookie on the panelist computer that enables the AME to identify the panelist whenever the panelist accesses tagged media and, thus, sends monitoring information to the AME. Additionally or alternatively, the AME may identify the panelists using other techniques (independent of cookies) by, for example, prompting the user to login or identify themselves. While AMEs are able to obtain user-level information for impressions from panelists (e.g., identify unique individuals associated with particular media impressions), most of the client devices providing monitoring information from the tagged pages are not panelists. Thus, the identity of most people accessing media remains unknown. The AME can use statistical methods to impute demographic information based on the data collected for panelists to the larger population of users providing data for the tagged media. However, panel sizes of AMEs remain small compared to the general population of users.

There are many database proprietors operating on the Internet. These database proprietors provide services to large numbers of subscribers. Examples of such database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, Hulu, etc.), etc. In exchange for the provision of services, the subscribers register with the database proprietors. Database proprietors set cookies and/or other device/user identifiers on the client devices of their subscribers to enable the database proprietors to recognize their subscribers when their subscribers visit their website(s) on the Internet domains of the database proprietors.

The protocols of the Internet make cookies inaccessible outside of the domain (e.g., Internet domain, domain name, etc.) on which they were set. Thus, a cookie set in, for example, the facebook.com domain (e.g., a first party) is accessible to servers in the facebook.com domain, but not to servers outside that domain. Therefore, although an AME (e.g., a third party) might find it advantageous to access the cookies set by the database proprietors, they are unable to do so. The inventions disclosed in Mazumdar et al., U.S. Pat. No. 8,370,489, which is incorporated by reference herein in its entirety, enable an AME to leverage the existing databases of database proprietors to collect more extensive Internet usage by extending the impression request process to encompass partnered database proprietors and by using such partners as interim data collectors. The inventions disclosed in Mazumdar accomplish this task by structuring the AME to respond to impression requests from clients (who may not be a member of an audience measurement panel and, thus, may be unknown to the AME) by redirecting the clients from the AME to a database proprietor, such as a social network site partnered with the AME, using an impression response. Such a redirection initiates a communication session between the client accessing the tagged media and the database proprietor. For example, the impression response received at the client device from the AME may cause the client device to send a second impression request to the database proprietor along with a cookie set by the database proprietor. In response to the database proprietor receiving this impression request from the client device, the database proprietor (e.g., Facebook) can access any cookie it has set on the client to thereby identify the client based on the internal records of the database proprietor.

In the event the client device corresponds to a subscriber of the database proprietor (as determined from the cookie associated with the client), the database proprietor logs/records a database proprietor demographic impression in association with the user/client device.

As used herein, an impression is defined to be an event in which a home or individual accesses and/or is exposed to media (e.g., an advertisement, content, a group of advertisements and/or a collection of content). As used herein, a demographic impression is an impression that can be matched to particular demographic information of a particular subscriber of the services of a database proprietor. The database proprietor has the demographic information for the particular subscriber because the subscriber would have provided such information when setting up an account to subscribe to the services of the database proprietor. In Internet media delivery, the number or quantity of times media (e.g., content, an advertisement, or advertisement campaign) is accessed by audience members is referred to as an impression count.

In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or connected device may transmit impression logs to the impression collection entity to log the media impressions.

A user of a computing device (e.g., a mobile device, a tablet, a laptop, etc.) and/or a television may be exposed to the same media via multiple devices (e.g., two or more of a mobile device, a tablet, a laptop, etc.) and/or via multiple media types (e.g., digital media available online, DTV media temporarily available online after broadcast, TV media, etc.). For example, a user may start watching The Walking Dead® television program on a television as part of TV media, pause the program, and continue to watch the program on a tablet as part of DTV media. In such an example, the exposure to the program may be logged by an AME twice, once for an impression log associated with the television exposure, and once for the impression request generated by a tag (e.g., census measurement science (CMS) tag) executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. Reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., panelists or non-panelists) for which an AME stores demographic information or can obtain demographic information. Deduplication is a process that is used to adjust cross-platform media exposure totals by reducing (e.g., eliminating) the double counting of individual audience members that were exposed to media via more than one platform and/or are represented in more than one database of media impressions used to determine the reach of the media.

As used herein, a unique audience is based on audience members distinguishable from one another. That is, a particular audience member exposed to particular media is measured as a single unique audience member regardless of how many times that audience member is exposed to that particular media or the particular platform(s) through which the audience member is exposed to the media. If that particular audience member is exposed multiple times to the same media, the multiple exposures for the particular audience member to the same media is counted as a single unique audience member. In this manner, impression performance for particular media is not disproportionately represented when a small subset of one or more audience members is exposed to the same media an excessively large number of times while a larger number of audience members is exposed fewer times or not at all to that same media. By tracking exposures to unique audience members, a unique audience measure may be used to determine a reach measure to identify how many unique audience members are reached by media. In some examples, increasing unique audience and, thus, reach, is useful for advertisers wishing to reach a larger audience base.

Although third-party cookies are useful for third-party measurement entities in many of the above-described techniques to track media accesses and to leverage demographic information from third-party database proprietors, use of third-party cookies may be limited or may cease in some or all online markets. That is, use of third-party cookies enables sharing anonymous personally identifiable information (PII) of subscribers across entities which can be used to identify and deduplicate audience members across database proprietor impression data. However, to reduce or eliminate the possibility of revealing user identities outside database proprietors by such anonymous data sharing across entities, some websites, internet domains, and/or web browsers will stop (or have already stopped) supporting third-party cookies. This will make it more challenging for third-party measurement entities to track media accesses via first-party servers. That is, although first-party cookies will still be supported and useful for media providers to track accesses to media via their own first-party servers, neutral third parties interested in generating neutral, unbiased audience metrics data will not have access to the impression data collected by the first-party servers using first-party cookies. Examples disclosed herein may be implemented with or without the availability of third-party cookies because, as mentioned above, the datasets used in the deduplication process are generated and provided by database proprietors, which may employ first-party cookies to track media impressions from which the datasets are generated.

Examples disclosed herein leverage raw digital census impressions from digital viewing, historical calibrated digital impressions provided by a database proprietor (also referred to as a data enrichment provider (DEP)), and demographic distribution data (e.g., using probability distribution functions (PDFs)) from linear TV to produce dTVR ratings that take into account demographic information and therefore are eligible for inclusion in TV ratings. Examples disclosed herein combine historical and current data. Examples disclosed herein utilize current data to assign initial demographics to current raw digital census impressions based on linear TV demographics. Disclosed examples utilize historical data to adjust the initial demographics of current digital census impressions to correct for differences between linear TV viewing and digital TV viewing as well as associations between demographic groups and device type usage.

As used herein, linear media, such as linear TV, refers to media provided via a live feed. For example, linear media programming includes a catalog of stations where each station includes a schedule of programs (e.g., shows, news segment, etc.) selected by a broadcaster and presented at set times. Additionally, as used herein, non-linear media, such as digital TV, refers to media with which a consumer can interact, for example, to select media to consume (e.g., to view and/or listen) at a time chosen by the consumer. For example, non-linear media is often consumed via subscription video on demand (SVOD) services such as Netflix®, Hulu®, Disney+®, Starz®, Amazon Video Direct®, Amazon Instant Video®, YouTube®, and Vimeo® but can also be consumed via free to use version of such services. Non-linear media also includes on demand services offered by cable providers and other media providers. Non-linear media can also refer to time-shifted media in which the media was recorded, paused, and then played back.

In some examples, linear TV demographic distributions are used to assign initial aggregated audience demographic data to raw census impression counts. In some examples, historical calibrated digital impressions are used to calibrate the raw census impression counts by accounting for known differences between linear and non-linear TV viewing. In this manner, examples disclosed herein convert raw census impression counts to ratings by receiving raw census pings of relevant digital viewing data, assigning aggregated demographics to the raw digital viewing data, correcting for known sources of error, and producing dTVR ratings.

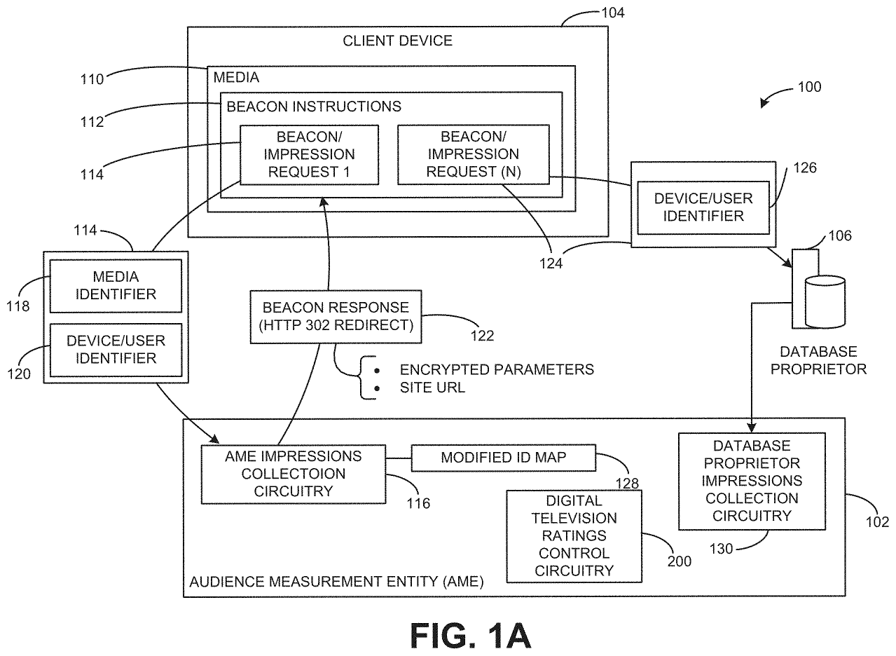

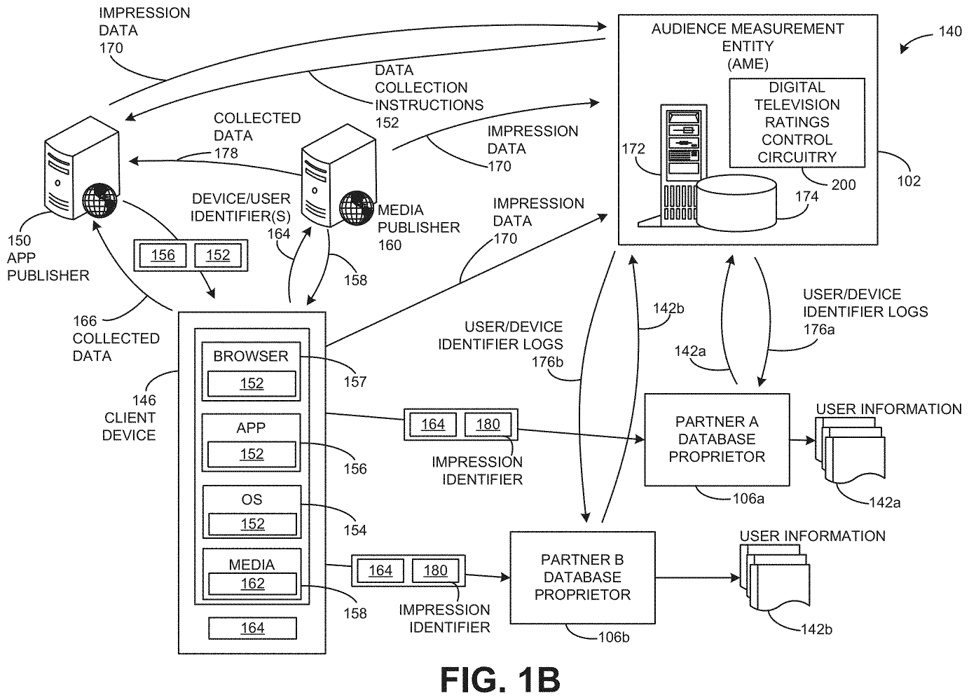

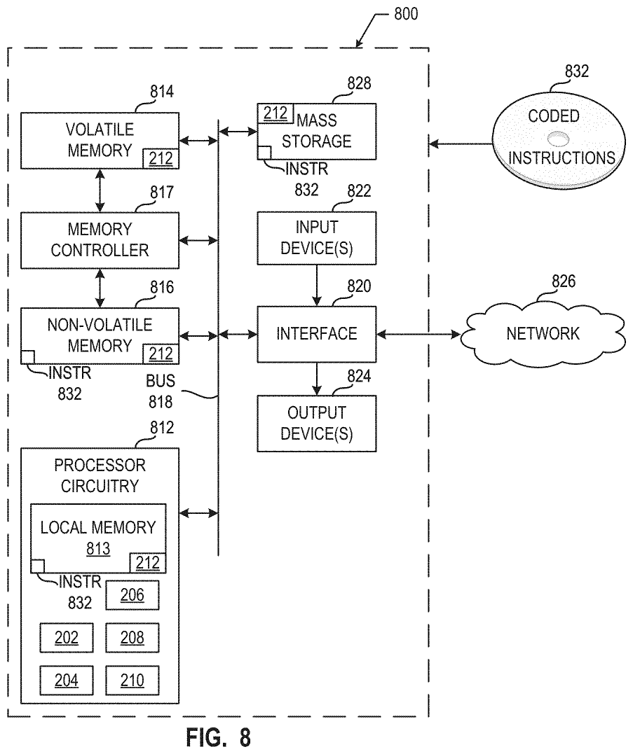

FIG. 1A is an example communication flow diagram 100 of an example manner in which an audience measurement entity (AME) 102 can collect audience measurement data including impressions of media accessed on, and reported by, client devices 104. In some examples, the AME 102 includes example digital television ratings (dTVR) control circuitry 200 to be implemented by a computer/processor system (e.g., the processor platform 800 of FIG. 8) that may analyze the collected audience measurement data to determine unique audience sizes and impression counts for different frequency intervals. In some examples, the AME 102 communicates with a database proprietor 106 to collect demographic information associated with audience members exposed to media. In some examples, the database proprietor 106 may provide summary or aggregate statistics indicative of the unique audience sizes and associated impression counts for different frequency intervals associated with audience members identified by the database proprietor 106. In some examples, the summary statistics may be further broken down by different demographic characteristics.

The example chain of events shown in FIG. 1A occurs when a client device 104 accesses media 110 for which the client device 104 reports an impression to the AME 102 and/or the database proprietor 106. In some examples, the client device 104 reports impressions for accessed media 110 based on instructions (e.g., monitoring instructions or beacon instructions) embedded in the media 110 that instruct the client device 104 (e.g., instruct a web browser or an app in the client device 104) to send beacon/impression requests 114, 124 to the AME 102 and/or the database proprietor 106. In such examples, the media 110 having the beacon instructions is referred to as tagged media. In other examples, the client device 104 reports impressions for accessed media 110 based on instructions embedded in apps or web browsers that execute on the client device 104 to send beacon/impression requests 114, 124to the AME 102 and/or the database proprietor 106 for corresponding media 110 accessed via those apps or web browsers. In any case, the beacon/impression requests 114, 124 include device/user identifiers (IDs) 120, 126 (e.g., AME IDs and/or database proprietor IDs) to allow the corresponding AME 102 and/or the corresponding database proprietor 106 to associate demographic information with resulting logged impressions.

In the illustrated example, the client device 104 accesses media 110 that is tagged with the beacon instructions 112. The beacon instructions 112 cause the client device 104 to send a beacon/impression request 114 to AME impressions collection circuitry 116 when the client device 104 accesses the media 110. For example, a web browser and/or app of the client device 104 executes the beacon instructions 112 in the media 110 which instruct the browser and/or app to generate and send the beacon/impression request 114. In the illustrated example, the client device 104 sends the beacon/impression request 114 using a network communication including an HTTP request addressed to the uniform resource locator (URL) of the AME impressions collection circuitry 116 at, for example, a first internet domain of the AME 102. The beacon/impression request 114 of the illustrated example includes a media identifier 118 (e.g., an identifier that can be used to identify content, an advertisement, and/or any other media) corresponding to the media 110. In some examples, the beacon/impression request 114 also includes a site identifier (e.g., a URL) of the website that served the media 110 to the client device 104 and/or a host website ID (e.g., www.acme.com) of the website that displays or presents the media 110. In the illustrated example, the beacon/impression request 114 includes a device/user identifier 120. In the illustrated example, the device/user identifier 120 that the client device 104 provides to the AME impressions collection circuitry 116 in the beacon impression request 114 is an AME ID because it corresponds to an identifier that the AME 102 uses to identify a panelist corresponding to the client device 104. In other examples, the client device 104 may not send the device/user identifier 120 until the client device 104 receives a request for the same from a server of the AME 102 in response to, for example, the AME impressions collection circuitry 116 receiving the beacon/impression request 114.

In some examples, the device/user identifier 120 may include a hardware identifier (e.g., an international mobile equipment identity (IMEI), a mobile equipment identifier (MEID), a media access control (MAC) address, etc.), an app store identifier (e.g., a Google Android ID, an Apple ID, an Amazon ID, etc.), a unique device identifier (UDID) (e.g., a non-proprietary UDID or a proprietary UDID such as used on the Microsoft Windows platform), an open source unique device identifier (OpenUDID), an open device identification number (ODIN), a login identifier (e.g., a username), an email address, user agent data (e.g., application type, operating system, software vendor, software revision, etc.), an Ad-ID (e.g., an advertising ID introduced by Apple, Inc. for uniquely identifying mobile devices for the purposes of serving advertising to such mobile devices), an Identifier for Advertisers (IDFA) (e.g., a unique ID for Apple iOS devices that mobile ad networks can use to serve advertisements), a Google Advertising ID, a Roku ID (e.g., an identifier for a Roku over the top (OTT) device), a third-party service identifier (e.g., advertising service identifiers, device usage analytics service identifiers, demographics collection service identifiers), web storage data, document object model (DOM) storage data, local shared objects (also referred to as “Flash cookies”), and/or any other identifier that the AME 102 stores in association with demographic information about users of the client devices 104. In this manner, when the AME 102 receives the device/user identifier 120, the AME 102 can obtain demographic information corresponding to a user of the client device 104 based on the device/user identifier 120 that the AME 102 receives from the client device 104. In some examples, the device/user identifier 120 may be encrypted (e.g., hashed) at the client device 104 so that only an intended final recipient of the device/user identifier 120 can decrypt the hashed identifier 120. For example, if the device/user identifier 120 is a cookie that is set in the client device 104 by the AME 102, the device/user identifier 120 can be hashed so that only the AME 102 can decrypt the device/user identifier 120. If the device/user identifier 120 is an IMEI number, the client device 104 can hash the device/user identifier 120 so that only a wireless carrier (e.g., the database proprietor 106) can decrypt the hashed identifier 120 to recover the IMEI for use in accessing demographic information corresponding to the user of the client device 104. By hashing the device/user identifier 120, an intermediate party (e.g., an intermediate server or entity on the Internet) receiving the beacon request cannot directly identify a user of the client device 104.

In response to receiving the beacon/impression request 114, the AME impressions collection circuitry 116 logs an impression for the media 110 by storing the media identifier 118 contained in the beacon/impression request 114. In the illustrated example of FIG. 1A, the AME impressions collection circuitry 116 also uses the device/user identifier 120 in the beacon/impression request 114 to identify AME panelist demographic information corresponding to a panelist of the client device 104. That is, the device/user identifier 120 matches a user ID of a panelist member (e.g., a panelist corresponding to a panelist profile maintained and/or stored by the AME 102). In this manner, the AME impressions collection circuitry 116 can associate the logged impression with demographic information of a panelist corresponding to the client device 104.

In some examples, the beacon/impression request 114 may not include the device/user identifier 120 if, for example, the user of the client device 104 is not an AME panelist. In such examples, the AME impressions collection circuitry 116 logs impressions regardless of whether the client device 104 provides the device/user identifier 120 in the beacon/impression request 114 (or in response to a request for the identifier 120). When the client device 104 does not provide the device/user identifier 120, the AME impressions collection circuitry 116 will still benefit from logging an impression for the media 110 even though it will not have corresponding demographics (e.g., an impression may be collected as a census impression). For example, the AME 102 may still use the logged impression to generate a total impressions count and/or a frequency of impressions (e.g., an impressions frequency) for the media 110. Additionally or alternatively, the AME 102 may obtain demographics information from the database proprietor 106 for the logged impression if the client device 104 corresponds to a subscriber of the database proprietor 106.

In the illustrated example of FIG. 1A, to compare or supplement panelist demographics (e.g., for accuracy or completeness) of the AME 102 with demographics from one or more database proprietors (e.g., the database proprietor 106), the AME impressions collection circuitry 116 returns a beacon response message 122 (e.g., a first beacon response) to the client device 104 including an HTTP re-direct message (e.g., a 302 Found redirect, a 303 See other redirect, etc.) and a URL of a participating database proprietor 106 at, for example, a second internet domain. In the illustrated example, the HTTP re-direct message in the beacon response 122 instructs the client device 104 to send a second beacon request 124 to the database proprietor 106. In other examples, instead of using an HTTP re-direct message, redirects may be implemented using, for example, an iframe source instruction (e.g., <iframe src=“ ”>) or any other instruction that can instruct a client device to send a subsequent beacon request (e.g., the second beacon request 124) to a participating database proprietor 106. In the illustrated example, the AME impressions collection circuitry 116 determines the database proprietor 106 specified in the beacon response 122 using a rule and/or any other suitable type of selection criteria or process. In some examples, the AME impressions collection circuitry 116 determines a particular database proprietor to which to redirect a beacon request based on, for example, empirical data indicative of which database proprietor is most likely to have demographic data for a user corresponding to the device/user identifier 120. In some examples, the beacon instructions 112 include a predefined URL of one or more database proprietors to which the client device 104 should send follow up beacon requests 124. In other examples, the same database proprietor is always identified in the first redirect message (e.g., the beacon response 122).

In the illustrated example of FIG. 1A, the beacon/impression request 124 may include a device/user identifier 126 that is a database proprietor ID because it is used by the database proprietor 106 to identify a subscriber of the client device 104 when logging an impression. In some instances (e.g., in which the database proprietor 106 has not yet set a database proprietor ID in the client device 104), the beacon/impression request 124 does not include the device/user identifier 126. In some examples, the database proprietor ID is not sent until the database proprietor 106 requests the same (e.g., in response to the beacon/impression request 124). In some examples, the device/user identifier 126 is a device identifier (e.g., an IMEI, a MEID, a MAC address, etc.), a web browser unique identifier (e.g., a cookie), a user identifier (e.g., a user name, a login ID, etc.), an Adobe Flash® client identifier, identification information stored in an HTML5 datastore, and/or any other identifier that the database proprietor 106 stores in association with demographic information about subscribers corresponding to the client devices 104. When the database proprietor 106 receives the device/user identifier 126, the database proprietor 106 can obtain demographic information corresponding to a user of the client device 104 based on the device/user identifier 126 that the database proprietor 106 receives from the client device 104. In some examples, the device/user identifier 126 may be encrypted (e.g., hashed) at the client device 104 so that only an intended final recipient of the device/user identifier 126 can decrypt the hashed identifier 126. For example, if the device/user identifier 126 is a cookie that is set in the client device 104 by the database proprietor 106, the device/user identifier 126 can be hashed so that only the database proprietor 106 can decrypt the device/user identifier 126. If the device/user identifier 126 is an IMEI number, the client device 104 can hash the device/user identifier 126 so that only a wireless carrier (e.g., the database proprietor 106) can decrypt the hashed identifier 126 to recover the IMEI for use in accessing demographic information corresponding to the user of the client device 104. By hashing the device/user identifier 126, an intermediate party (e.g., an intermediate server or entity on the Internet) receiving the beacon request cannot directly identify a user of the client device 104. For example, if the intended final recipient of the device/user identifier 126 is the database proprietor 106, the AME 102 cannot recover identifier information when the device/user identifier 126 is hashed by the client device 104 for decrypting only by the intended database proprietor 106.

Although only a single database proprietor 106 is shown in FIG. 1A, the impression reporting/collection process of FIG. 1A may be implemented using multiple database proprietors. In some such examples, the beacon instructions 112 cause the client device 104 to send beacon/impression requests 124 to numerous database proprietors. For example, the beacon instructions 112 may cause the client device 104 to send the beacon/impression requests 124 to the numerous database proprietors in parallel or in daisy chain fashion. In some such examples, the beacon instructions 112 cause the client device 104 to stop sending beacon/impression requests 124 to database proprietors once a database proprietor has recognized the client device 104. In other examples, the beacon instructions 112 cause the client device 104 to send beacon/impression requests 124 to database proprietors so that multiple database proprietors can recognize the client device 104 and log a corresponding impression. In any case, multiple database proprietors are provided the opportunity to log impressions and provide corresponding demographics information if the user of the client device 104 is a subscriber of services of those database proprietors.

In some examples, prior to sending the beacon response 122 to the client device 104, the AME impressions collection circuitry 116 replaces site IDs (e.g., URLs) of media provider(s) that served the media 110 with modified site IDs (e.g., substitute site IDs) which are discernable only by the AME 102 to identify the media provider(s). In some examples, the AME impressions collection circuitry 116 may also replace a host website ID (e.g., www.acme.com) with a modified host site ID (e.g., a substitute host site ID) which is discernable only by the AME 102 as corresponding to the host website via which the media 110 is presented. In some examples, the AME impressions collection circuitry 116 also replaces the media identifier 118 with a modified media identifier 118 corresponding to the media 110. In this way, the media provider of the media 110, the host website that presents the media 110, and/or the media identifier 118 are obscured from the database proprietor 106, but the database proprietor 106 can still log impressions based on the modified values which can later be deciphered by the AME 102 after the AME 102 receives logged impressions from the database proprietor 106. In some examples, the AME impressions collection circuitry 116 does not send site IDs, host site IDs, the media identifier 118 or modified versions thereof in the beacon response 122. In such examples, the client device 104 provides the original, non-modified versions of the media identifier 118, site IDs, host IDs, etc., to the database proprietor 106.

In the illustrated example, the AME impression collection circuitry 116 maintains a modified ID mapping table 128 that maps original site IDs with modified (or substitute) site IDs, original host site IDs with modified host site IDs, and/or maps modified media identifiers to the media identifiers such as the media identifier 118 to obfuscate or hide such information from database proprietors such as the database proprietor 106. Also in the illustrated example, the AME impressions collection circuitry 116 encrypts all of the information received in the beacon/impression request 114 and the modified information to prevent any intercepting parties from decoding the information. The AME impressions collection circuitry 116 of the illustrated example sends the encrypted information in the beacon response 122 to the client device 104 so that the client device 104 can send the encrypted information to the database proprietor 106 in the beacon/impression request 124. In the illustrated example, the AME impressions collection circuitry 116 uses an encryption that can be decrypted by the database proprietor 106 site specified in the HTTP re-direct message.

Periodically or aperiodically, the audience measurement data collected by the database proprietor 106 is provided to a database proprietor impressions collection circuitry 130 of the AME 102 as, for example, batch data. In some examples, the audience measurement data may be combined or aggregated to generate a media impression frequency distribution for individuals exposed to the media 110 that the database proprietor 106 was able to identify (e.g., based on the device/user identifier 126). During a data collecting and merging process to combine demographic and audience measurement data from the AME 102 and the database proprietor(s) 106, impressions logged by the AME 102 for the client devices 104 that do not have a database proprietor ID will not correspond to impressions logged by the database proprietor 106 because the database proprietor 106 typically does not log impressions for the client devices that do not have database proprietor IDs.

Additional examples that may be used to implement the beacon instruction processes of FIG. 1A are disclosed in Mazumdar et al., U.S. Pat. No. 8,370,489, which is hereby incorporated herein by reference in its entirety. In addition, other examples that may be used to implement such beacon instructions are disclosed in Blumenau, U.S. Pat. No. 6,108,637.

FIG. 1B depicts an example system 142 to collect impression information based on user information 142a, 142b from distributed database proprietors 106 (designated as 106a and 106b in FIG. 1B) for associating with impressions of media presented at a client device 146. In the illustrated examples, user information 142a, 142b or user data includes one or more of demographic data, purchase data, and/or other data indicative of user activities, behaviors, and/or preferences related to information accessed via the Internet, purchases, media accessed on electronic devices, physical locations (e.g., retail or commercial establishments, restaurants, venues, etc.) visited by users, etc. Thus, the user information 142a, 142b may indicate and/or be analyzed to determine the impression frequency of individual users with respect to different media accessed by the users. In some examples, such impression information, may be combined or aggregated to generate a media impression frequency distribution for all users exposed to particular media for whom the database proprietor has particular user information 142a, 142b. More particularly, in the illustrated example of FIG. 1B, the AME 102 includes the example dTVR control circuitry 200 to analyze the collected audience measurement data to determine frequency distributions for media impressions as described more fully below.

In the illustrated example of FIG. 1B, the client device 146 may be a mobile device (e.g., a smart phone, a tablet, etc.), an internet appliance, a smart television, an internet terminal, a computer, or any other device capable of presenting media received via network communications. In some examples, to track media impressions on the client device 146, an audience measurement entity (AME) 102 partners with or cooperates with an app publisher 150 to download and install data collection instructions 152 (that may be executed and/or instantiated by processor circuitry) on the client device 146. The app publisher 150 of the illustrated example may be a software app developer that develops and distributes apps to mobile devices and/or a distributor that receives apps from software app developers and distributes the apps to mobile devices. The data collection instructions 152 may be included in other software loaded onto the client device 146, such as the operating system 154, an application (or app) 156, a web browser 117, and/or any other software.

Any of the example operating system 154, the example app program 156, and/or the example browser 117 may present media 158 received from a media publisher 160. The media 158 may be an advertisement, video, audio, text, a graphic, a web page, news, educational media, entertainment media, or any other type of media. In the illustrated example, a media ID 162 is provided in the media 158 to enable identifying the media 158 so that the AME 102 can credit the media 158 with media impressions when the media 158 is presented on the client device 146 or any other device that is monitored by the AME 102.

The data collection instructions 152 of the illustrated example include instructions (e.g., Java, java script, or any other computer language or script) that, when executed and/or instantiated by the client device 146, cause the client device 146 to collect the media ID 162 of the media 158 presented by the app program 156, the browser 117, and/or the client device 146, and to collect one or more device/user identifier(s) 164 stored in the client device 146. The device/user identifier(s) 164 of the illustrated example include identifiers that can be used by corresponding ones of the partner database proprietors 106a-b to identify the user or users of the client device 146, and to locate user information 142a-b corresponding to the user(s). For example, the device/user identifier(s) 164 may include hardware identifiers (e.g., an IMEI, a MEID, a MAC address, etc.), an app store identifier (e.g., a Google Android ID, an Apple ID, an Amazon ID, etc.), a UDID (e.g., a non-proprietary UDID or a proprietary UDID such as used on the Microsoft Windows platform), an OpenUDID, an ODIN, a login identifier (e.g., a username), an email address, user agent data (e.g., application type, operating system, software vendor, software revision, etc.), an Ad-ID (e.g., an advertising ID introduced by Apple, Inc. for uniquely identifying mobile devices for the purposes of serving advertising to such mobile devices), an IDFA (e.g., a unique ID for Apple iOS devices that mobile ad networks can use to serve advertisements), a Google Advertising ID, a Roku ID (e.g., an identifier for a Roku OTT device), third-party service identifiers (e.g., advertising service identifiers, device usage analytics service identifiers, demographics collection service identifiers), web storage data, DOM storage data, local shared objects (also referred to as “Flash cookies”), etc. In examples in which the media 158 is accessed using an application and/or browser (e.g., the app 156 and/or the browser 117) that do not employ cookies, the device/user identifier(s) 164 are non-cookie identifiers such as the example identifiers noted above. In examples in which the media 158 is accessed using an application or browser that does employ cookies, the device/user identifier(s) 164 may additionally or alternatively include cookies. In some examples, fewer or more device/user identifier(s) 164 may be used. In addition, although only two partner database proprietors 106a-b are shown in FIG.1B, the AME 102 may partner with any number of partner database proprietors to collect distributed user information (e.g., the user information 142a-b).

In some examples, the client device 146 may not allow access to identification information stored in the client device 146. For such instances, the disclosed examples enable the AME 102 to store an AME-provided identifier (e.g., an identifier managed and tracked by the AME 102) in the client device 146 to track media impressions on the client device 146. For example, the AME 102 may provide instructions such as the data collection instructions 152 to set an AME-provided identifier in memory space accessible by and/or allocated to the app program 156 and/or the browser 117, and the data collection instructions 152 use the identifier as a device/user identifier 164. In such examples, the AME-provided identifier set by the data collection instructions 152 persists in the memory space even when the app program 156 and the data collection instructions 152 and/or the browser 117 and the data collection instructions 152 are not running. In this manner, the same AME-provided identifier can remain associated with the client device 146 for extended durations. In some examples in which the data collection instructions 152 set an identifier in the client device 146, the AME 102 may recruit a user of the client device 146 as a panelist, and may store user information collected from the user during a panelist registration process and/or collected by monitoring user activities/behavior via the client device 146 and/or any other device used by the user and monitored by the AME 102. In this manner, the AME 102 can associate user information of the user (from panelist data stored by the AME 102) with media impressions attributed to the user on the client device 146. As used herein, a panelist is a user registered on a panel maintained by a ratings entity (e.g., the AME 102) that monitors and estimates audience exposure to media.

In the illustrated example, the data collection instructions 152, when executed and/or instantiated, send the media ID 162 and the one or more device/user identifier(s) 164 as collected data 166 to the app publisher 150. Alternatively, the data collection instructions 152, when executed and/or instantiated, may send the collected data 166 to another collection entity (other than the app publisher 150) that has been contracted by the AME 102 or is partnered with the AME 102 to collect media ID's (e.g., the media ID 162) and device/user identifiers (e.g., the device/user identifier(s) 164) from user devices (e.g., the client device 146). In the illustrated example, the app publisher 150 (or a collection entity) sends the media ID 162 and the device/user identifier(s) 164 as impression data 170 to impression collection circuitry 172 (e.g., an impression collection server or a data collection server) at the AME 102. The impression data 170 of the illustrated example may include one media ID 162 and one or more device/user identifier(s) 164 to report a single impression of the media 158, or it may include numerous media ID's 162 and device/user identifier(s) 164 based on numerous instances of collected data (e.g., the collected data 166) received from the client device 146 and/or other devices to report multiple impressions of media.

In the illustrated example, the impression collection circuitry 172 stores the impression data 170 in an AME media impressions store 174 (e.g., a database or other data structure). Subsequently, the AME 102 sends the device/user identifier(s) 164 to corresponding partner database proprietors (e.g., the partner database proprietors 106a-b) to receive user information (e.g., the user information 142a-b) corresponding to the device/user identifier(s) 164 from the partner database proprietors 106a-b so that the AME 102 can associate the user information with corresponding media impressions of media (e.g., the media 158) presented at the client device 146.

More particularly, in some examples, after the AME 102 receives the device/user identifier(s) 164, the AME 102 sends device/user identifier logs 176a-b to corresponding partner database proprietors (e.g., the partner database proprietors 106a-b). Each of the device/user identifier logs 176a-b may include a single device/user identifier 164, or it may include numerous aggregate device/user identifiers 164 received over time from one or more devices (e.g., the client device 146). After receiving the device/user identifier logs 176a-b, each of the partner database proprietors 106a-b looks up its users corresponding to the device/user identifiers 164 in the respective logs 176a-b. In this manner, each of the partner database proprietors 106a-b collects user information 142a-b corresponding to users identified in the device/user identifier logs 176a-b for sending to the AME 102. For example, if the partner database proprietor 106a is a wireless service provider and the device/user identifier log 176a includes IMEI numbers recognizable by the wireless service provider, the wireless service provider accesses its subscriber records to find users having IMEI numbers matching the IMEI numbers received in the device/user identifier log 176a. When the users are identified, the wireless service provider copies the users' user information to the user information 142a for delivery to the AME 102.

In some other examples, the data collection instructions 152, when executed and/or instantiated, collect the device/user identifier(s) 164 from the client device 146. The example data collection instructions 152, when executed and/or instantiated, send the device/user identifier(s) 164 to the app publisher 150 in the collected data 166, and it also sends the device/user identifier(s) 164 to the media publisher 160. In such other examples, the data collection instructions 152, when executed and/or instantiated, do not collect the media ID 162 from the media 158 at the client device 146 as the data collection instructions 152 do in the example system 142 of FIG. 1B. Instead, the media publisher 160 that publishes the media 158 to the client device 146 retrieves the media ID 162 from the media 158 that it publishes. The media publisher 160 then associates the media ID 162 to the device/user identifier(s) 164 received from the data collection instructions 152 executing at and/or being instantiated by the client device 146, and sends collected data 178 to the app publisher 150 that includes the media ID 162 and the associated device/user identifier(s) 164 of the client device 146. For example, when the media publisher 160 sends the media 158 to the client device 146, it does so by identifying the client device 146 as a destination device for the media 158 using one or more of the device/user identifier(s) 164 received from the client device 146. In this manner, the media publisher 160 can associate the media ID 162 of the media 158 with the device/user identifier(s) 164 of the client device 146 indicating that the media 158 was sent to the particular client device 146 for presentation (e.g., to generate an impression of the media 158).

In some other examples in which the data collection instructions 152, when executed and/or instantiated, send the device/user identifier(s) 164 to the media publisher 160, the data collection instructions 152 do not collect the media ID 162 from the media 158 at the client device 146. Instead, the media publisher 160 that publishes the media 158 to the client device 146 also retrieves the media ID 162 from the media 158 that it publishes. The media publisher 160 then associates the media ID 162 with the device/user identifier(s) 164 of the client device 146. The media publisher 160 then sends the media impression data 170, including the media ID 162 and the device/user identifier(s) 164, to the AME 102. For example, when the media publisher 160 sends the media 158 to the client device 146, it does so by identifying the client device 146 as a destination device for the media 158 using one or more of the device/user identifier(s) 164. In this manner, the media publisher 160 can associate the media ID 162 of the media 158 with the device/user identifier(s) 164 of the client device 146 indicating that the media 158 was sent to the particular client device 146 for presentation (e.g., to generate an impression of the media 158). In the illustrated example, after the AME 102 receives the impression data 170 from the media publisher 160, the AME 102 can then send the device/user identifier logs 176a-b to the partner database proprietors 106a-b to request the user information 142a-b as described above.

Although the media publisher 160 is shown separate from the app publisher 150 in FIG. 1, the app publisher 150 may implement at least some of the operations of the media publisher 160 to send the media 158 to the client device 146 for presentation. For example, advertisement providers, media providers, or other information providers may send media (e.g., the media 158) to the app publisher 150 for publishing to the client device 146 via, for example, the app program 156 when it is executing on and/or being instantiated by the client device 146. In such examples, the app publisher 150 implements the operations described above as being performed by the media publisher 160.

Additionally or alternatively, in contrast with the examples described above in which the client device 146 sends identifiers to the AME 102 (e.g., via the application publisher 150, the media publisher 160, and/or another entity), in other examples the client device 146 (e.g., the data collection instructions 152 installed on the client device 146) sends the identifiers (e.g., the device/user identifier(s) 164) directly to the respective database proprietors 106a, 106b (e.g., not via the AME 102). In such examples, the example client device 146 sends the media identifier 162 to the AME 102 (e.g., directly or through an intermediary such as via the application publisher 150), but does not send the media identifier 162 to the database proprietors 106a-b.

As mentioned above, the example partner database proprietors 106a-b provide the user information 142a-b to the example AME 102 for matching with the media identifier 162 to form media impression information. As also mentioned above, the database proprietors 106a-b are not provided copies of the media identifier 162. Instead, the client provides the database proprietors 106a-b with impression identifiers 180. An impression identifier uniquely identifies an impression event relative to other impression events of the client device 146 so that an occurrence of an impression at the client device 146 can be distinguished from other occurrences of impressions. However, the impression identifier 180 does not itself identify the media associated with that impression event. In such examples, the impression data 170 from the client device 146 to the AME 102 also includes the impression identifier 180 and the corresponding media identifier 162. To match the user information 142a-b with the media identifier 162, the example partner database proprietors 106a-b provide the user information 142a-b to the AME 102 in association with the impression identifier 180 for the impression event that triggered the collection of the user information 142a-b. In this manner, the AME 102 can match the impression identifier 180 received from the client device 146 to a corresponding impression identifier 180 received from the partner database proprietors 106a-b to associate the media identifier 162 received from the client device 146 with demographic information in the user information 142a-b received from the database proprietors 106a-b. The impression identifier 180 can additionally be used for reducing or avoiding duplication of demographic information. For example, the example partner database proprietors 106a-b may provide the user information 142a-b and the impression identifier 180 to the AME 102 on a per-impression basis (e.g., each time a client device 146 sends a request including an encrypted identifier 164a-b and an impression identifier 180 to the partner database proprietor 106a-b) and/or on an aggregated basis (e.g., send a set of user information 142a-b, which may include indications of multiple impressions (e.g., multiple impression identifiers 180), to the AME 102 presented at the client device 146).

The impression identifier 180 provided to the AME 102 enables the AME 102 to distinguish unique impressions and avoid over counting a number of unique users and/or devices viewing the media. For example, the relationship between the user information 142a from the partner A database proprietor 106a and the user information 142b from the partner B database proprietor 106b for the client device 146 is not readily apparent to the AME 102. By including an impression identifier 180 (or any similar identifier), the example AME 102 can associate user information corresponding to the same user between the user information 142a-b based on matching impression identifiers 180 stored in both of the user information 142a-b. The example AME 102 can use such matching impression identifiers 180 across the user information 142a-b to avoid over counting mobile devices and/or users (e.g., by only counting unique users instead of counting the same user multiple times).

A same user may be counted multiple times if, for example, an impression causes the client device 146 to send multiple device/user identifiers to multiple different database proprietors 106a-b without an impression identifier (e.g., the impression identifier 180). For example, a first one of the database proprietors 106a sends first user information 142a to the AME 102, which signals that an impression occurred. In addition, a second one of the database proprietors 106b sends second user information 142b to the AME 102, which signals (separately) that an impression occurred. In addition, separately, the client device 146 sends an indication of an impression to the AME 102. Without knowing that the user information 142a-b is from the same impression, the AME 102 has an indication from the client device 146 of a single impression and indications from the database proprietors 106a-b of multiple impressions.

To avoid over counting impressions, the AME 102 can use the impression identifier 180. For example, after looking up user information 142a-b, the example partner database proprietors 106a-b transmit the impression identifier 180 to the AME 102 with corresponding user information 142a-b. The AME 102 matches the impression identifier 180 obtained directly from the client device 146 to the impression identifier 180 received from the database proprietors 106a-b with the user information 142a-b to thereby associate the user information 142a-b with the media identifier 162 and to generate impression information. This is possible because the AME 102 received the media identifier 162 in association with the impression identifier 180 directly from the client device 146. Therefore, the AME 102 can map user data from two or more database proprietors 106a-b to the same media exposure event, thus avoiding double counting.

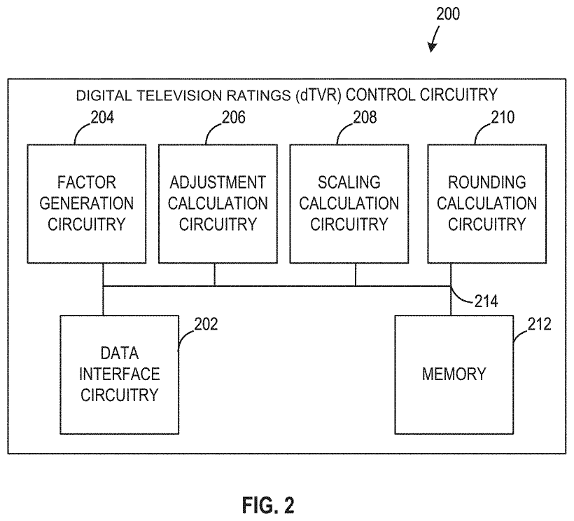

FIG. 2 is a block diagram of an example implementation of the dTVR control circuitry 200 to assign demographic distribution data to raw census impression data in accordance with teachings of this disclosure. The example dTVR control circuitry 200 illustrated in FIG. 2 includes example data interface circuitry 202, example factor generation circuitry 204, example adjustment calculation circuitry 206, example scaling calculation circuitry 208, example rounding calculation circuitry 210, and example memory 212. In the example of FIG. 2, the example data interface circuitry 202, the example factor generation circuitry 204, the example adjustment calculation circuitry 206, the example scaling calculation circuitry 208, the example rounding calculation circuitry 210, and the example memory 212 are in communication via an example bus 214.

In the illustrated example of FIG. 2, the data interface circuitry 202 receives data from a data source and provides the data to the factor generation circuitry 204, the adjustment calculation circuitry 206, the scaling calculation circuitry 208, the rounding calculation circuitry 210, and/or the memory 212. Additionally, in some examples, the data interface circuitry 202 receives data from the factor generation circuitry 204, the adjustment calculation circuitry 206, the scaling calculation circuitry 208, the rounding calculation circuitry 210, and/or the memory 212, and transmits the data to an external destination.

In some examples, the data received by the example data interface circuitry 202 illustrated in FIG. 2 includes application data. In examples disclosed herein, application data includes, for example, current raw digital census impression data and/or current linear TV probability distribution function(s) (LTV-PDF(s)). In some examples, the data received by the example data interface circuitry 202 illustrated in FIG. 2 includes training data. Training data includes, for example, historical data such as historical raw digital census impression data, historical LTV-PDF(s), and/or historical calibrated digital impressions.

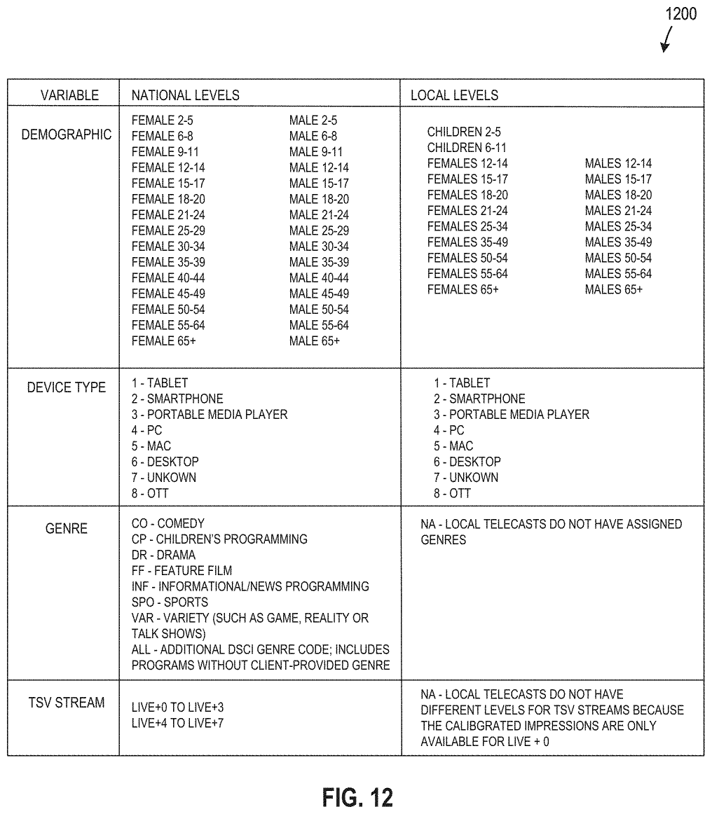

In examples disclosed herein, the raw digital census impression data (current or historical) includes the number of digitally viewed minutes of all TV telecasts that returned a ping from a digital device. In some examples, the raw digital census impression data (current or historical) includes national raw digital census impression data and local raw digital census impression data. National raw digital census impression data includes, for example, fields for broadcast date, program that was broadcast (e.g., telecast), whether the program was broadcast as a Time-Shifted Viewing (TSV) stream, and device type. Example national raw digital census impression data includes time-shifted viewing up to seven days after the broadcast date. Local raw digital census impression data includes, for example, fields for Designated Marketing Area (DMA), station code, the start time of the quarter hour for which the data was collected, and/or device type. Example local raw digital census impression data includes viewing for the broadcast date. Example raw digital census impression data is illustrated in FIG. 12. FIG. 12 illustrates an example table 1200.

In examples disclosed herein, an LTV-PDF (current or historical) includes a TV probability distribution function created from linear TV viewing. For example, an LTV-PDF (current or historical) is a proportion of total viewing for a telecast/quarter hour that is assigned to each demographic group that is recorded. In some examples, LTV-PDFs (current or historical) across demographics sum to 1 for each telecast/quarter hour. In some examples, the data interface circuitry 202 obtains an LTV-PDF (current or historical) from home television viewing panels. Generally, device type is not taken into account for LTV-PDFs (current or historical) because LTV-PDFs are based on television viewing.

In some examples, LTV-PDFs (current or historical) include national LTV-PDFs and local LTV-PDFs. National LTV-PDFs include, for example, fields for broadcast date, program that was broadcast (e.g., telecast), whether the program was broadcast as a TSV stream, and/or demographics. Example national LTV-PDFs include time-shifted viewing up to seven days after the broadcast date. Local LTV-PDFs include, for example, fields for DMA, station code, the start time of the quarter hour for which the data was collected, and/or demographics. Example local LTV-PDFs include viewing for the broadcast date.

In examples disclosed herein, historical calibrated digital impressions include the number of digitally viewed minutes of all TV telecasts after aggregated demographics have been assigned by the database proprietor (e.g., the database proprietor 106 of FIG. 1A, the database proprietors 106a-b of FIG. 1B, etc.) and calibration has been applied by the AME 102. Example calibration includes correcting for unknown gender, misattribution for device sharing, non-coverage, and/or co-viewing. In some examples, the historical calibrated digital demographic impressions include national calibrated digital impressions and/or local calibrated digital impressions. In some examples, calibration includes scaling the national calibrated digital impressions, rounding the national calibrated digital impressions, and rounding the local calibrated digital impressions to the nearest integer. In the example of FIG. 2, historical calibrated digital impressions serve as a truth set for evaluating the impact of the dTVR ratings produced by the dTVR control circuitry 200. Future updates to the historical calibrated digital impressions may be made based on additional data collected by the database proprietor (e.g., the database proprietor 106 of FIG. 1A, the database proprietors 106a-b of FIG. 1B, etc.).

In examples disclosed herein, national calibrated digital impressions include, for example, fields for broadcast date, program that was broadcast (e.g., telecast), whether the program was broadcast as a TSV stream, device type, and/or demographics. Example national calibrated digital impressions includes time-shifted viewing up to seven days after the broadcast date. Local calibrated digital impressions include, for example, fields for DMA, station code, the start time of the quarter hour for which the data was collected, device type, and/or demographics. Example local calibrated digital impressions include viewing for the broadcast date.

In the illustrated example of FIG. 2, the example dTVR control circuitry 200 includes the example factor generation circuitry 204 to generate one or more factors that are applied to digital impressions to account for differences between digital TV viewing and linear TV viewing. For example, by applying a current LTV-PDF to current raw digital census impression data, an AME can obtain a general idea of the demographic distribution of the digital impressions. However, there are likely differences between demographic distributions for linear TV relative to digital TV due to the manner in which linear TV and digital TV are served to end users. For example, linear TV is often served to end users via a single device type (e.g., a television) at set times according to a set schedule of media provided via a live feed or broadcast whereas digital TV can be served to end users via multiple device types (e.g., a smartphone, a tablet, a portable media player, etc.) at any time the end users prefer, and the media served can be whatever media is available from the digital TV provider. As such, the example factor generation circuitry 204 generates one or more demographic adjustment factors and/or one or more device adjustment factors to account for such differences between linear TV and digital TV.

In the illustrated example of FIG. 2, the factor generation circuitry 204 generates a demographic adjustment factor by calculating a ratio of digital-PDF impressions to linear-PDF impressions. To generate digital-PDF impressions, the example factor generation circuitry 204 applies one or more historical digital TV PDFs (DTV-PDFs) to the historical raw digital census impression data. For example, the factor generation circuitry 204 multiplies the historical raw digital census impressions by the one or more historical DTV-PDFs to determine the digital-PDF impressions. The resulting digital-PDF impressions represent the demographic-level impressions for digital viewing.

In the illustrated example of FIG. 2, the factor generation circuitry 204 generates a historical DTV-PDF by subtracting co-viewing impressions from the historical calibrated digital impressions and then calculating the proportion of total digital telecast/quarter hour impressions that are attributed to each demographic that is recorded in the historical calibrated digital impressions. For example, the factor generation circuitry 204 determines the proportion of total digital telecast/quarter hour impressions that are attributed to each demographic by determining a ratio between the sum of historical calibrated digital impressions distributed by demographic and the sum of the historical calibrated digital impressions. In the example of FIG. 2, the factor generation circuitry 204 subtracts the co-viewing impressions from the historical calibrated digital impressions because the historical calibrated digital impressions include adjustments for co-viewing. In this manner, the factor generation circuitry 204 prevents double counting in later calculations.

In the illustrated example of FIG. 2, to generate the linear-PDF impressions, the factor generation circuitry 204 applies one or more historical LTV-PDFs to historical raw digital census impression data. For example, the factor generation circuitry 204 multiplies the historical raw digital census impressions by the one or more historical LTV-PDFs to determine the linear-PDF impressions. The resulting linear-PDF impressions represent the demographic-level impressions for linear viewing.

As described above, in the illustrated example of FIG. 2, the factor generation circuitry 204 generates a demographic adjustment factor by calculating a ratio of digital-PDF impressions to linear-PDF impressions. For example, the factor generation circuitry 204 determines the sum of digital-PDF impressions across all telecasts and the sum of the linear-PDF impressions across all telecasts. The example factor generation circuitry 204 determines a demographic adjustment factor as a ratio between the sum of digital-PDF impressions and the sum of the linear-PDF impressions. In examples disclosed herein, granular demographic adjustment factors should be used when available. However, if granular demographic adjustment factors are not available, less granular, broad, demographic adjustment factors may be used. However, broad demographic adjustment factors should be prohibited from being set to zero.

In the illustrated example of FIG. 2, the factor generation circuitry 204 generates one or more device adjustment factors per device type to adjust the demographic-level impressions because demographic distributions can vary by device. For example, viewers may be exposed to DTV on many types of devices including tablets, smartphones, desktops, and portable media players. To determine the one or more device adjustment factors, the factor generation circuitry 204 utilizes historical associations between demographics and devices to further adjust the digital impressions. For example, the historical associations between demographics and devices are represented as a distribution of demographics across device type (e.g., which demographics were exposed to media presented by which device).

In the illustrated example of FIG. 2, to generate the one or more device adjustment factors, the factor generation circuitry 204 calculates the ratio of historical calibrated demographic digital impressions and historical computed demographic digital impressions. In the example of FIG. 2, historical calibrated digital impressions already include variations by device type. To prevent double counting in later calculations, the factor generation circuitry 204 subtracts co-viewing impressions from the historical calibrated digital impressions to obtain the historical calibrated demographic digital impressions.

In the illustrated example of FIG. 2, to determine historical computed demographic digital impressions, the factor generation circuitry 204 applies one or more historical LTV-PDFs and the one or more demographic adjustment factors to the historical raw digital census impressions and normalizes the resulting historical computed demographic digital impressions. For example, the factor generation circuitry 204 multiplies the historical raw digital census impressions by the one or more LTV-PDFs and the one or more demographic adjustment factors. Additionally, the example factor generation circuitry 204 normalizes the resulting historical computed demographic digital impressions such that the historical computed demographic digital impressions add up to the total historical raw digital census impressions for each telecast/quarter hour. The one or more device adjustment factors capture the difference between impressions where the demographic distributions differ by device type (e.g., historical calibrated demographic digital impressions) and impressions where the demographic distributions are the same across all device types (e.g., historical computed demographic digital impressions).

As described above, in the illustrated example of FIG. 2, the factor generation circuitry 204 generates a device adjustment factor by calculating a ratio of historical calibrated demographic digital impressions and historical computed demographic digital impressions. For example, the factor generation circuitry 204 determines the sum of the historical calibrated demographic digital impressions across all telecasts and the sum of the historical computed demographic digital impressions across all telecasts. The example factor generation circuitry 204 determines a device adjustment factor as a ratio between the sum of the historical calibrated demographic digital impressions and the sum of the historical computed demographic digital impressions. In examples disclosed herein, granular device adjustment factors should be used when available. In some examples however, if granular device adjustment factors are not available, less granular, broad, device adjustment factors may be used. However, broad device adjustment factors should be prohibited from being set to zero.

In the illustrated example of FIG. 2, the factor generation circuitry 204 calculates one or more co-viewing factors. Example co-viewing factors are represented as a matrix of proportions where each demographic group that is recorded is considered as both a primary demographic and a secondary demographic. In the example of FIG. 2, each primary demographic has a corresponding, different, secondary demographic with each primary-secondary demographic pair having a corresponding co-viewing factor. For example, for national co-viewing, each potential primary and secondary demographic pair has a genre-specific co-viewing factor used in dTVR. In some examples, the example factor generation circuitry 204 generates the genre-specific co-viewing factor by calculating the proportion of impressions by a primary demographic that had a secondary demographic as a co-viewer for a given genre.

Additionally, for example, for local co-viewing, each potential primary and secondary demographic pair has a local co-viewing factor used in dTVR. In some examples, the example factor generation circuitry 204 generates a local co-viewing factor by calculating the proportion of impressions by a primary demographic that had the secondary demographic as a co-viewer. In the example of FIG. 2, genre is not incorporated in the calculation of local co-viewing factors. However, in additional or alternative examples, genre may be considered in the determination of local co-viewing factors. Additional examples of co-viewing factor calculation and/or application are disclosed in Rao et al., U.S. Pat. No. 10,803,475, which is hereby incorporated herein by reference in its entirety.

In the illustrated example of FIG. 2, the example dTVR control circuitry 200 includes the example adjustment calculation circuitry 206 to apply the adjustment factors (e.g., the one or more demographic adjustment factors, the one or more device adjustment factors, and/or the one or more co-viewing factors) to application data. In some examples, the example adjustment calculation circuitry 206 calculates digital demographic-level impressions for each telecast/quarter hour by applying the one or more demographic adjustment factors to current raw digital census impressions. For example, the example adjustment calculation circuitry 206 multiplies the current raw digital census impressions by one or more current LTV-PDFs and the one or more demographic adjustment factors to determine the digital demographic-level impressions. Additionally or alternatively, the adjustment calculation circuitry 206 normalizes the digital demographic-level impressions so that the digital demographic-level impressions add up to the total of the current raw digital census impressions for each telecast/quarter hour. For example, the adjustment calculation circuitry 206 determines the product of the digital demographic-level impressions and the ratio of the current total telecast raw digital census impressions and the current total telecast digital demographic-level impressions.

In the illustrated example of FIG. 2, the example adjustment calculation circuitry 206 calculates digital device-demographic-level impressions for each telecast/quarter hour by applying the one or more device adjustment factors to the digital demographic-level impressions. For example, the adjustment calculation circuitry 206 multiplies the digital demographic-level impressions by the one or more device adjustment factors to determine the digital device-demographic-level impressions. In some examples, the example adjustment calculation circuitry 206 normalizes the digital device-demographic-level impressions such that the digital device-demographic-level impressions add up to the total of the current raw digital census impressions for each telecast/quarter hour. For example, the adjustment calculation circuitry 206 determines the product of the digital device-demographic-level impressions and the ratio of the current total telecast raw digital census impressions and the current total telecast digital device-demographic-level impressions.

Generally, raw census impressions do not take into account co-viewing (e.g., where more than one person is watching). Thus, to account for co-viewing, in some examples, the example adjustment calculation circuitry 206 of the illustrated example of FIG. 2 calculates co-viewing impressions. For example, the adjustment calculation circuitry 206 performs a dot product of the co-viewing factor matrix and the digital device-demographic-level impressions to determine respective co-viewing impressions. The example co-viewing factor matrix includes co-viewing factors for desktop devices and non-desktop devices. In the example of FIG. 2, the co-viewing factors of non-desktop devices are set to zero. However, in additional or alternative examples, co-viewing factors for non-desktop devices may be set to one or more other values.

In the illustrated example of FIG. 2, to determine digital device-demographic-level impressions with co-viewing, the adjustment calculation circuitry 206 adds the co-viewing impressions to the digital device-demographic-level impressions. For example, for national co-viewing, the adjustment calculation circuitry 206 adds the national co-viewing impressions to the corresponding secondary demographics of the national digital device-demographic-level impressions. Additionally, for example, for local co-viewing, the adjustment calculation circuitry 206 adds the local co-viewing impressions to the corresponding secondary demographics of the local digital device-demographic-level impressions. In some examples, digital device-demographic-level impressions are limited such that the added co-viewing impressions do not increase the digital device-demographic-level impressions by more than 50 percent. However, in additional or alternative examples, any other limit (including no limit whatsoever) may be used.

In the illustrated example of FIG. 2, the dTVR control circuitry 200 includes the example scaling calculation circuitry 208 and the example rounding calculation circuitry 210. The scaling calculation circuitry 208 and the rounding calculation circuitry 210 work in conjunction to determine final adjusted impression distribution data. As such, although illustrated as separate structure, in some examples, the scaling calculation circuitry 208 and the rounding calculation circuitry 210 may be implemented by the same structure (e.g., on the same die, in the same package, etc.).

In the illustrated example of FIG. 2, the rounding calculation circuitry 210 rounds national digital device-demographic-level impressions to the nearest integer. In the example of FIG. 2, the scaling calculation circuitry 208 determines one or more national scaling factors by determining a ratio of national digital device-demographic-level impressions to rounded national digital device-demographic-level impressions. The example scaling calculation circuitry 208 scales the national digital device-demographic-level impressions by multiplying the unrounded national digital device-demographic-level impressions by the one or more national scaling factors. In this manner, the scaling calculation circuitry 208 scales the national digital device-demographic-level impressions such that custom minute-level impressions are consistent with currency telecast-level impressions. For example, some clients of the AME 102 may request that national digital device-demographic level impressions be reported at the total telecast level for currency while other clients of the AME 102 may request that national digital device-demographic level impressions be reported at the minute level. The rounding calculation circuitry 210 determines the final national digital device-demographic-level impressions by rounding the scaled national digital device-demographic-level impressions to the nearest integer.

In the illustrated example of FIG. 2, scaling is not performed for local digital device-demographic-level impressions. However, in additional or alternative examples, scaling may be performed for local digital device-demographic-level impressions. To determine the final local digital device-demographic-level impressions, the rounding calculation circuitry 210 rounds the local digital device-demographic-level impressions to the nearest integer.

In the illustrated example of FIG. 2, the dTVR control circuitry 200 includes the example memory 212. In some examples, the example memory 212 stores historical training data and/or application data. In some examples, the example memory 212 stores calculated adjustment factors such as one or more demographic adjustment factors, one or more device adjustment factors, and/or one or more co-viewing factors. In some examples, the example memory 212 stores algorithms for calculating the one or more adjustment factors and/or one or more adjusted impression distribution data.

In the illustrated example of FIG. 2, the memory 212 may be implemented by a volatile memory (e.g., a Synchronous Dynamic Random-Access Memory (SDRAM), Dynamic Random-Access Memory (DRAM), RAMBUS Dynamic Random-Access Memory (RDRAM), etc.) and/or a non-volatile memory (e.g., flash memory). The example memory 212 may additionally or alternatively be implemented by one or more double data rate (DDR) memories, such as DDR, DDR2, DDR3, DDR4, mobile DDR (mDDR), etc. The example memory 212 may additionally or alternatively be implemented by one or more mass storage devices such as hard disk drive(s), compact disk drive(s), digital versatile disk drive(s), solid-state disk drive(s), etc.

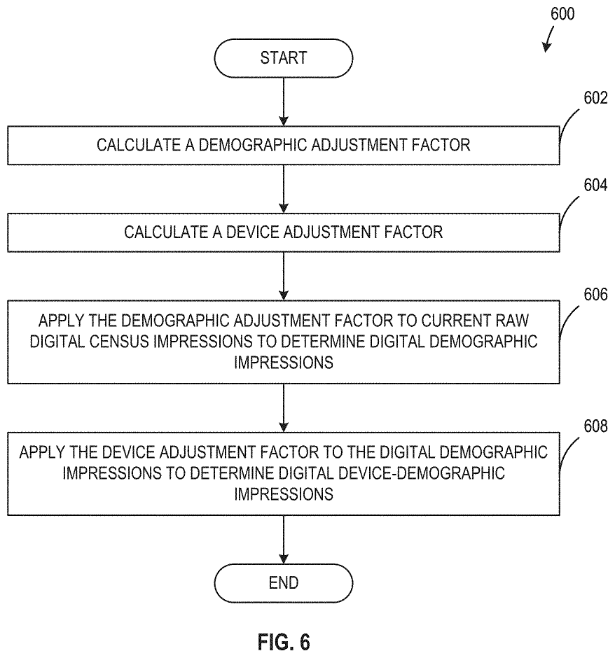

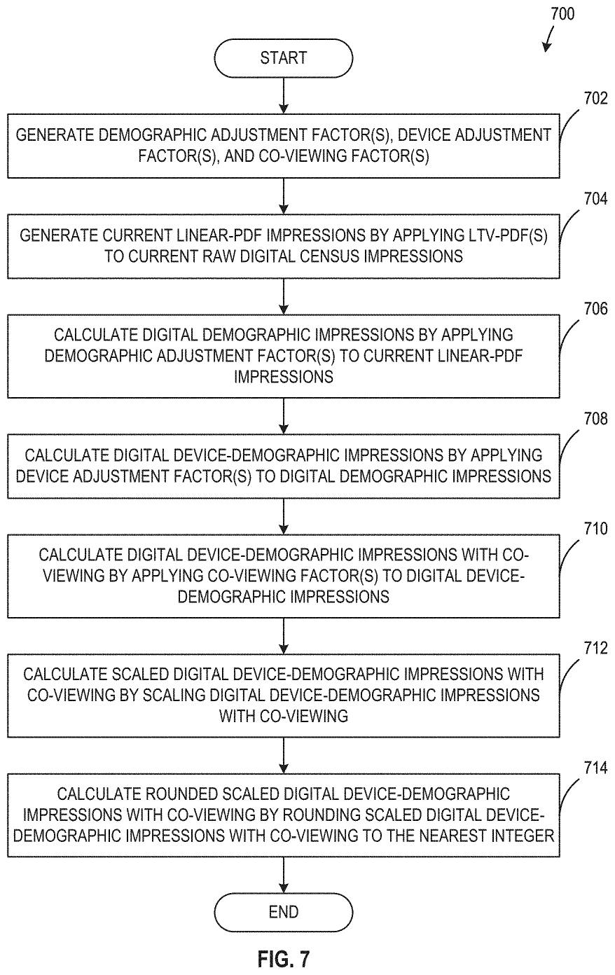

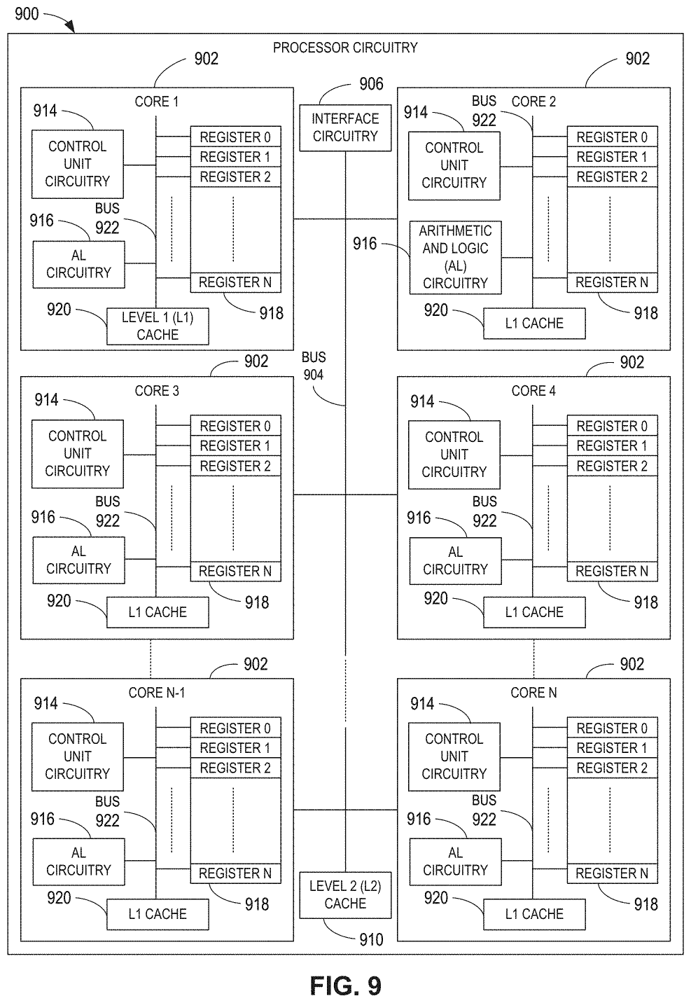

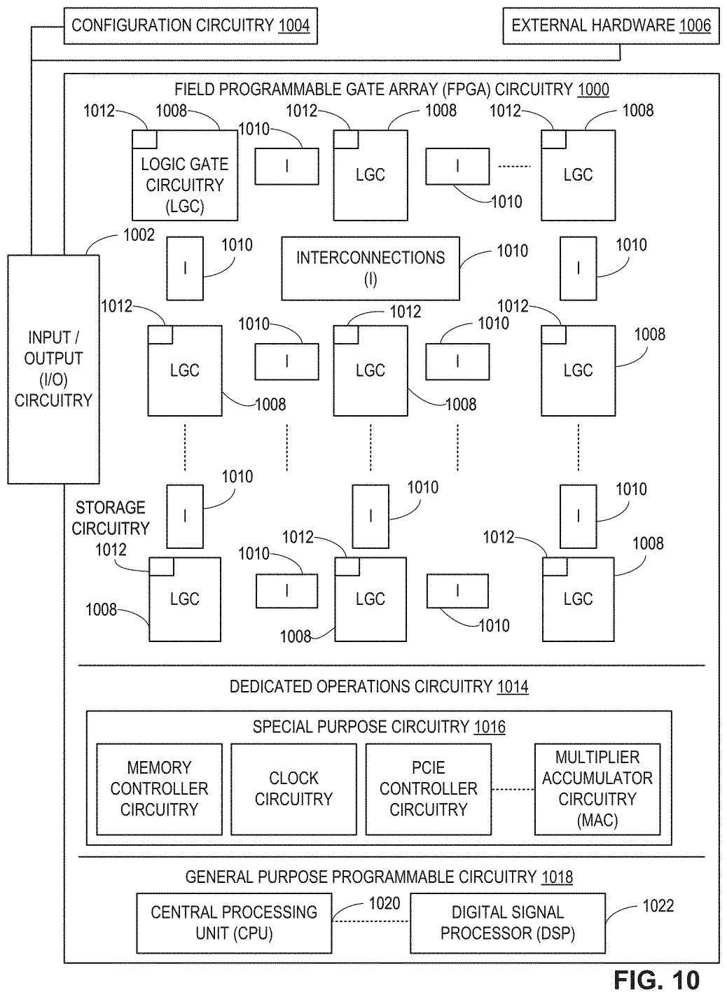

In some examples, the dTVR control circuitry 200 includes means for generating one or more adjustment factors. For example, the means for generating one or more adjustment factors may be implemented by the factor generation circuitry 204. In some examples, the factor generation circuitry 204 may be implemented by machine executable instructions and/or operations such as that implemented by at least blocks 602 and 604 of FIG. 6 and/or at least block 702 of FIG. 7 executed by processor circuitry, which may be implemented by the example processor circuitry 812 of FIG. 8, the example microprocessor 900 of FIG. 9, and/or the example Field Programmable Gate Array (FPGA) circuitry 1000 of FIG. 10. In other examples, the factor generation circuitry 204 is implemented by other hardware logic circuitry, hardware implemented state machines, and/or any other combination of hardware, software, and/or firmware. For example, the factor generation circuitry 204 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the dTVR control circuitry 200 includes means for adjusting. For example, the means for adjusting may be implemented by the adjustment calculation circuitry 206. In some examples, the adjustment calculation circuitry 206 may be implemented by machine executable instructions and/or operations such as that implemented by at least blocks 606 and 608 of FIG. 6 and/or at least blocks 704, 706, 708, and 710 of FIG. 7 executed by processor circuitry, which may be implemented by the example processor circuitry 812 of FIG. 8, the example microprocessor 900 of FIG. 9, and/or the example Field Programmable Gate Array (FPGA) circuitry 1000 of FIG. 10. In other examples, the adjustment calculation circuitry 206 is implemented by other hardware logic circuitry, hardware implemented state machines, and/or any other combination of hardware, software, and/or firmware. For example, the adjustment calculation circuitry 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the dTVR control circuitry 200 includes means for scaling. For example, the means for scaling may be implemented by the scaling calculation circuitry 208. In some examples, the scaling calculation circuitry 208 may be implemented by machine executable instructions and/or operations such as that implemented by at least block 712 of FIG. 7 executed by processor circuitry, which may be implemented by the example processor circuitry 812 of FIG. 8, the example microprocessor 900 of FIG. 9, and/or the example Field Programmable Gate Array (FPGA) circuitry 1000 of FIG. 10. In other examples, the scaling calculation circuitry 208 is implemented by other hardware logic circuitry, hardware implemented state machines, and/or any other combination of hardware, software, and/or firmware. For example, the scaling calculation circuitry 208 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the dTVR control circuitry 200 includes means for rounding. For example, the means for rounding may be implemented by the rounding calculation circuitry 210. In some examples, the rounding calculation circuitry 210 may be implemented by machine executable instructions and/or operations such as that implemented by at least block 714 of FIG. 7 executed by processor circuitry, which may be implemented by the example processor circuitry 812 of FIG. 8, the example microprocessor 900 of FIG. 9, and/or the example Field Programmable Gate Array (FPGA) circuitry 1000 of FIG. 10. In other examples, the rounding calculation circuitry 210 is implemented by other hardware logic circuitry, hardware implemented state machines, and/or any other combination of hardware, software, and/or firmware. For example, the rounding calculation circuitry 210 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the dTVR control circuitry 200 of FIGS. 1A and/or 1B is illustrated in FIG. 2, one or more of the elements, processes, and/or devices illustrated in FIG. 2 may be combined, divided, re-arranged, omitted, eliminated, and/or implemented in any other way. Further, the example data interface control circuitry 202, the example factor generation circuitry 204, the example adjustment calculation circuitry 206, the example scaling calculation circuitry 208, the example rounding calculation circuitry 210, the example memory 212, and/or, more generally, the example dTVR control circuitry 200 of FIGS. 1A, 1B, and/or 2, may be implemented by hardware, software, firmware, and/or any combination of hardware, software, and/or firmware. Thus, for example, any of the example data interface circuitry 202, the example factor generation circuitry 204, the example adjustment calculation circuitry 206, the example scaling calculation circuitry 208, the example rounding calculation circuitry 210, the example memory 212, and/or, more generally, the example dTVR control circuitry 200, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example data interface circuitry 202, the example factor generation circuitry 204, the example adjustment calculation circuitry 206, the example scaling calculation circuitry 208, the example rounding calculation circuitry 210, and the example memory 212 is/are hereby expressly defined to include a non-transitory computer readable storage device or storage disk such as a memory, a digital versatile disk (DVD), a compact disk (CD), a Blu-ray disk, etc., including the software and/or firmware. Further still, the example dTVR control circuitry 200 of FIGS. 1A, 1B, and/or 2 may include one or more elements, processes, and/or devices in addition to, or instead of, those illustrated in FIG. 2, and/or may include more than one of any or all of the illustrated elements, processes and devices.

Flowcharts representative of example hardware logic circuitry, machine readable instructions and/or operations, hardware implemented state machines, and/or any combination thereof for implementing the dTVR control circuitry 200 of FIGS. 1A, 1B, and/or 2 are shown in FIGS. 6 and/or 7. The machine readable instructions and/or operations may be one or more executable and/or instantiate-able programs or portion(s) of an executable and/or instantiate-able program for execution and/or instantiation by processor circuitry, such as the processor circuitry 812 shown in the example processor platform 800 discussed below in connection with FIG. 8 and/or the example processor circuitry discussed below in connection with FIGS. 9 and/or 10. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.) or non-volatile memory (e.g., FLASH memory, an HDD, etc.) associated with processor circuitry located in one or more hardware devices, but the entire program and/or parts thereof could alternatively be executed and/or instantiated by one or more hardware devices other than the processor circuitry and/or embodied in firmware or dedicated hardware. The machine readable instructions and/or operations may be distributed across multiple hardware devices and/or executed and/or instantiated by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 6 and/or 7, many other methods of implementing the example dTVR control circuitry 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions and/or operations described herein may be stored in one or more of a compressed format, an encrypted format, a fragmented format, a compiled format, an executable format, a packaged format, etc. Machine readable instructions and/or operations as described herein may be stored as data or a data structure (e.g., as portions of instructions, code, representations of code, etc.) that may be utilized to create, manufacture, and/or produce machine executable instructions and/or operations. For example, the machine readable instructions and/or operations may be fragmented and stored on one or more storage devices and/or computing devices (e.g., servers) located at the same or different locations of a network or collection of networks (e.g., in the cloud, in edge devices, etc.). The machine readable instructions and/or operations may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions and/or operations may be stored in multiple parts, which are individually compressed, encrypted, and/or stored on separate computing devices, wherein the parts when decrypted, decompressed, and/or combined form a set of machine executable instructions and/or operations that implement one or more operations that may together form a program such as that described herein.

In another example, the machine readable instructions and/or operations may be stored in a state in which they may be read by processor circuitry, but require addition of a library (e.g., a dynamic link library (DLL)), a software development kit (SDK), an application programming interface (API), etc., in order to execute and/or instantiate the machine readable instructions and/or operations on a particular computing device or other device. In another example, the machine readable instructions and/or operations may need to be configured (e.g., settings stored, data input, network addresses recorded, etc.) before the machine readable instructions and/or operations and/or the corresponding program(s) can be executed and/or instantiated in whole or in part. Thus, machine readable media, as used herein, may include machine readable instructions and/or operations and/or program(s) regardless of the particular format or state of the machine readable instructions and/or operations and/or program(s) when stored or otherwise at rest or in transit.

The machine readable instructions and/or operations described herein can be represented by any past, present, or future instruction language, scripting language, programming language, etc. For example, the machine readable instructions and/or operations may be represented using any of the following languages: C, C++, Java, C#, Perl, Python, JavaScript, HyperText Markup Language (HTML), Structured Query Language (SQL), Swift, etc.

As mentioned above, the example operations of FIGS. 6 and/or 7 may be implemented using executable instructions and/or operations (e.g., computer and/or machine readable instructions and/or operations) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

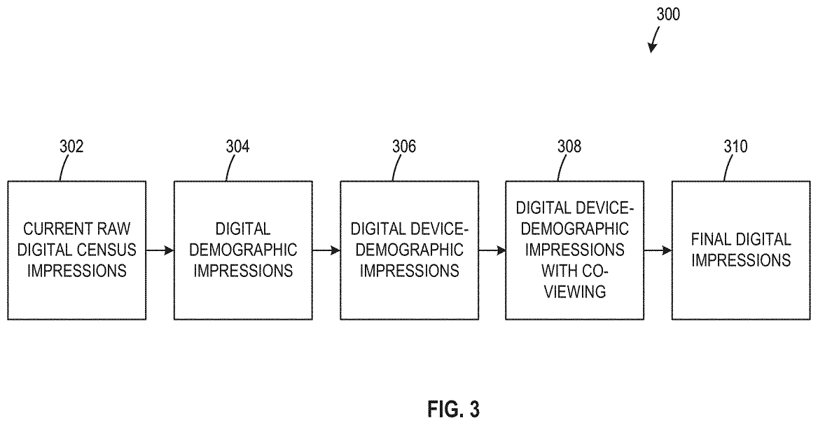

FIG. 3 is a data flow diagram illustrating an example data flow 300 to assign demographic distribution data to digital TV ratings. In the illustrated example of FIG. 3, the example adjustment calculation circuitry 206 (FIG. 2) applies one or more current LTV-PDFs and one or more demographic adjustment factors to example current raw digital census impressions 302 to calculate example digital demographic impressions 304. For example, the adjustment calculation circuitry 206 multiplies the current raw digital census impressions 302 by the one or more current LTV-PDFs and the one or more demographic adjustment factors. After such multiplication, the example adjustment calculation circuitry 206 normalizes the resulting impressions to determine the example digital demographic impressions 304. For example, the adjustment calculation circuitry 206 normalizes the digital demographic impressions 304 such that the digital demographic impressions 304 add up to the total of the current raw digital census impressions 302 for each telecast/quarter hour.

In the illustrated example of FIG. 3, the example adjustment calculation circuitry 206 calculates example digital device-demographic impressions 306 by applying one or more device adjustment factors to the digital demographic impressions 304. For example, to calculate the example digital device-demographic impressions 306, the adjustment calculation circuitry 206 multiplies the digital demographic impressions 304 by the one or more device adjustment factors. After such multiplication, the example adjustment calculation circuitry 206 normalizes the resulting impressions to determine the example digital device-demographic impressions 306. For example, the adjustment calculation circuitry 206 normalizes the digital device-demographic impressions 306 such that the digital device-demographic impressions 306 add up to the total of the current raw digital census impressions 302 for each telecast/quarter hour.

In the illustrated example of FIG. 3, the example adjustment calculation circuitry 206 calculates example digital device-demographic impressions with co-viewing 308 by applying one or more co-viewing factors to the digital device-demographic impressions 306. For example, the adjustment calculation circuitry 206 performs one or more dot products of one or more co-viewing factor matrices (e.g., one for local and one for national) and the digital device-demographic impressions 306 to determine respective local and national co-viewing impressions. For example, for national ones of the digital device-demographic impressions 306, the adjustment calculation circuitry 206 adds the determined number of national co-viewing impressions to the secondary demographic associated with the national ones of the digital device-demographic impressions 306. Additionally, for local ones of the digital device-demographic impressions 306, the example adjustment calculation circuitry 206 adds the determined number of local co-viewing impressions to the secondary demographic associated with the local ones of the digital device-demographic impressions 306.

In the illustrated example of FIG. 3, the example scaling calculation circuitry 208 (FIG. 2) scales the national ones of the digital device-demographic impressions with co-viewing 308. For example, the scaling calculation circuitry 208 determines one or more national scaling factors by determining a ratio of national ones of the digital device-demographic impressions with co-viewing 308 to rounded national ones of the digital device-demographic impressions with co-viewing 308 (as determined by the rounding calculation circuitry 210 of FIG. 2). The example scaling calculation circuitry 208 scales the national ones of the digital device-demographic impressions with co-viewing 308 by multiplying the digital device-demographic impressions with co-viewing 308 by the one or more national scaling factors.

In the illustrated example of FIG. 3, the rounding calculation circuitry 210 rounds the national ones of the digital device-demographic impressions with co-viewing 308 to the nearest integer so that the scaling calculation circuitry 208 may determine the one or more national scaling factors. Additionally, the example rounding calculation circuitry 210 rounds the scaled national ones of the digital device-demographic impressions with co-viewing 308 and local ones of the digital device-demographic impressions with co-viewing 308 to the nearest integer to generate example final digital impressions 310.

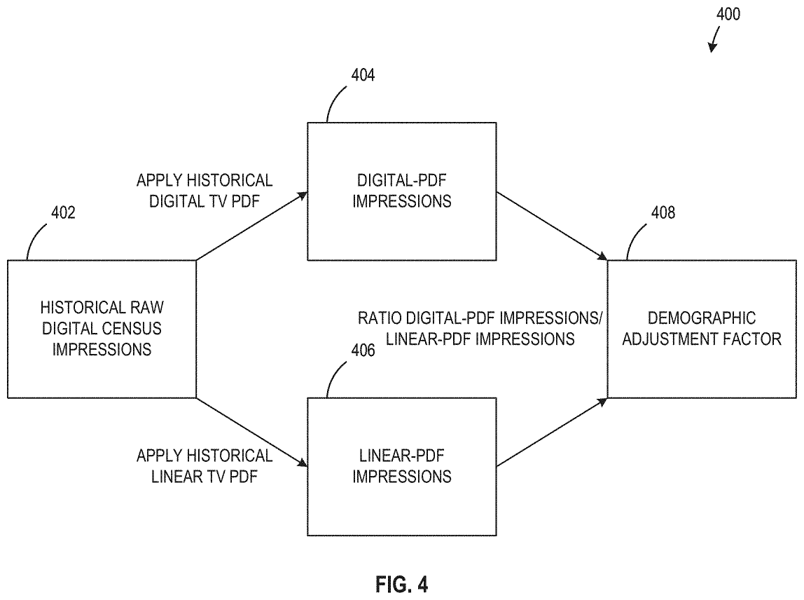

FIG. 4 is a data flow diagram illustrating an example data flow 400 to calculate one or more demographic adjustment factors. In the illustrated example, the example factor generation circuitry 204 (FIG. 2) applies a historical DTV-PDF to historical raw digital census impressions 402 to calculate example digital-PDF impressions 404. For example, the factor generation circuitry 204 multiplies the historical raw digital census impressions 402 by the one or more historical DTV-PDFs to determine the digital-PDF impressions 404. In some examples, historical DTV-PDFs are referred to as historical digital television PDFs. To generate the historical DTV-PDF, the factor generation circuitry 204 subtracts co-viewing impressions from the historical calibrated digital impressions and calculates the proportion of total digital telecast/quarter hour impressions that are attributed to each demographic group that is recorded in the historical calibrated digital impressions. In the illustrated example of FIG. 4, the co-viewing impressions are subtracted from the historical calibrated digital impressions (e.g., deduplication) to prevent double counting in later calculations.

In the illustrated example of FIG. 4, the example factor generation circuitry 204 calculates example linear-PDF impressions 406 by applying a historical LTV-PDF to the example historical raw digital census impressions 402. For example, the factor generation circuitry 204 multiplies the historical raw digital census impressions 402 by an LTV-PDF to determine the example linear-PDF impressions 406. In some examples, historical LTV-PDFs are referred to as historical linear TV PDFs. In the illustrated example of FIG. 4, the LTV-PDF is based on impressions of one or more home television viewing panels. In some examples, the example factor generation circuitry 204 generates an example demographic adjustment factor 408 by calculating a ratio of the example digital-PDF impressions 404 to the example linear-PDF impressions 406.

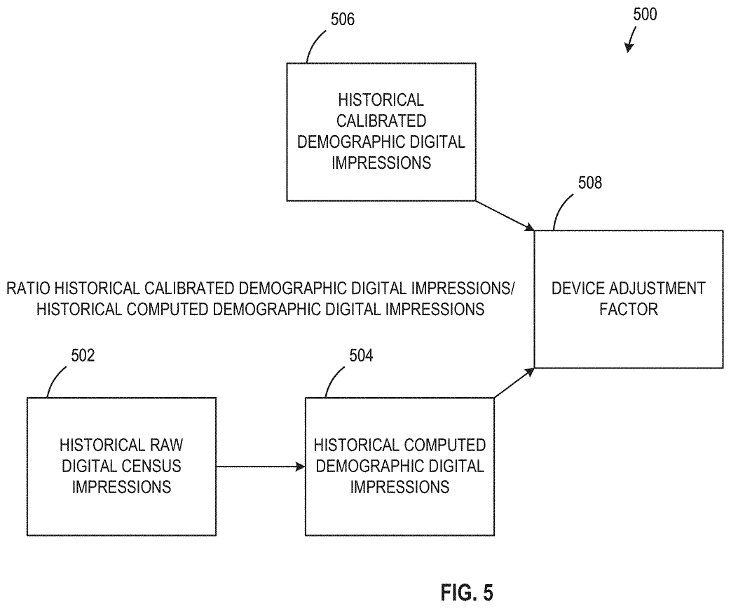

FIG. 5 is a data flow diagram illustrating an example data flow 500 to calculate one or more device adjustment factors. In the illustrated example of FIG. 5, the example factor generation circuitry 204 (FIG. 2) applies one or more example historical LTV-PDFs and one or more example demographic adjustment factors to example historical raw digital census impressions 502 and normalizes the resulting example historical computed demographic digital impressions 504 such that the example historical computed demographic digital impressions 504 add up to the total historical raw digital census impressions 502 for each telecast/quarter hour. For example, the factor generation circuitry 204 multiplies the historical raw digital census impressions 502 by the one or more historical LTV-PDFs and one or more demographic adjustment factors. In the illustrated example of FIG. 5, the example factor generation circuitry 204 determines a ratio of example historical calibrated demographic digital impressions 506 to the example historical computed demographic digital impressions 504 to calculate one or more device adjustment factors 508.

FIG. 6 is a flowchart representative of example machine readable instructions and/or example operations 600 that may be executed and/or instantiated by processor circuitry to implement the dTVR controller 200 of FIGS. 1A, 1B, and/or 2 to apply demographics to current raw digital census impressions. The machine readable instructions and/or operations 600 of FIG. 6 begin at block 602 at which the example factor generation circuitry 204 (FIG. 2) calculates a demographic adjustment factor. For example, the factor generation circuitry 204 calculates the demographic adjustment factor based on digital PDF impressions and linear PDF impressions. At block 604, the example factor generation circuitry 204 calculates a device adjustment factor. For example, the factor generation circuitry 204 calculates the device adjustment factor based on historical calibrated demographic digital impressions and historical computed demographic digital impressions.

In the illustrated example of FIG. 6, at block 606, the example adjustment calculation circuitry 206 (FIG. 2) applies the demographic adjustment factor to current raw digital census impressions to determine digital demographic impressions. For example, at block 606, the example adjustment calculation circuitry 206 (FIG. 2) multiplies the current raw digital census impressions by one or more current LTV-PDFs and the one or more demographic adjustment factors to determine the digital demographic-level impressions. At block 608, the example adjustment calculation circuitry 206 applies the device adjustment factor to the digital demographic impressions to determine digital device-demographic impressions. For example, at block 608, the adjustment calculation circuitry 206 multiplies the digital demographic impressions by the device adjustment factor to determine the digital device-demographic impressions.

FIG. 7 is a flowchart representative of example machine readable instructions and/or operations 700 that may be executed and/or instantiated by processor circuitry to implement the dTVR control circuitry 200 of FIGS. 1A, 1B, and/or 2 to assign demographics to digital impressions. The machine readable instructions and/or operations 700 of FIG. 7 begin at block 702 at which the example factor generation circuitry 204 (FIG. 2) generates one or more demographic adjustment factors, one or more device adjustment factors, and one or more co-viewing factors. In some examples, the factor generation circuitry 204 calculates two separate demographic adjustment factors, one national and one local. In some examples, the example factor generation circuitry 204 calculates two separate device adjustment factors, one national and one local. In some examples, the example factor generation circuitry 204 calculates two separate co-viewing factors, one national and one local.

In the illustrated example of FIG. 7, at block 702, to calculate the one or more demographic adjustment factors, the factor generation circuitry 204 calculates one or more ratios of example digital-PDF impressions to example linear-PDF impressions. For example, at block 702, the factor generation circuitry 204 determines the digital-PDF impressions by multiplying historical raw digital census impressions by one or more historical DTV-PDFs. Additionally, at block 702, the factor generation circuitry 204 determines the one or more historical DTV-PDFs by subtracting co-viewing impressions from historical calibrated digital impressions and calculating a proportion of total digital telecast/quarter hour impressions that are attributed to each demographic group that is recorded in the historical calibrated digital impressions. Also, at block 702, the factor generation circuitry 204 determines the linear-PDF impressions by multiplying the historical raw digital census impressions by an LTV-PDF.

In the illustrated example of FIG. 7, at block 702, to calculate the one or more device adjustment factors, the factor generation circuitry 204 determines one or more ratios of example historical calibrated demographic digital impressions to example historical computed demographic digital impressions. Additionally, at block 702, the factor generation circuitry 204 multiplies the historical raw digital census impressions by one or more historical LTV-PDFs and the one or more demographic adjustment factors to determine the historical computed demographic digital impressions. Also, at block 702, the factor generation circuitry 204 normalizes the resulting historical computed demographic digital impressions such that the historical computed demographic digital impressions add up to the total historical raw digital census impressions for each telecast/quarter hour.

In the illustrated example of FIG. 7, at block 702, to calculate the one or more co-viewing factors, the factor generation circuitry 204 calculates one or more proportions of impressions by one or more primary demographics that had one or more corresponding secondary demographics as a co-viewer. For example, at block 702, the factor generation circuitry 204 generates one or more genre-specific national co-viewing factors by calculating one or more proportions of impressions by one or more primary demographics that had one or more secondary demographics as a co-viewer for a given genre. Additionally, at block 702, the factor generation circuitry 204 generates one or more local co-viewing factors by calculating one or more proportions of impressions by one or more primary demographics that had one or more corresponding secondary demographics as a co-viewer.

In the illustrated example of FIG. 7, at block 704, the example adjustment calculation circuitry 206 (FIG. 2) generates one or more linear-PDF impressions by applying one or more LTV-PDFs to current raw digital census impressions. For example, at block 704, the adjustment calculation circuitry 206 multiplies the current raw digital census impressions by the one or more LTV-PDFs. In some examples, at block 704, the adjustment calculation circuitry 206 generates two sets of linear-PDF impressions, one national and one local.

In the illustrated example of FIG. 7, at block 706, the example adjustment calculation circuitry 206 calculates digital demographic impressions by applying the one or more demographic adjustment factors to the one or more current linear-PDF impressions. For example, at block 706, the example adjustment calculation circuitry 206 multiplies the one or more current LTV-PDF impressions by the one or more demographic adjustment factors to determine the digital demographic impressions. Additionally, at block 706, the adjustment calculation circuitry 206 normalizes the digital demographic impressions such that the digital demographic impressions add up to the total of the current raw digital census impressions for each telecast/quarter hour. In some examples, at block 706, the example adjustment calculation circuitry 206 calculates two sets of digital demographic impressions, one national and one local.

In the illustrated example of FIG. 7, at block 708, the example adjustment calculation circuitry 206 generates one or more digital device-demographic impressions by applying the one or more device adjustment factors to the digital demographic impressions. For example, at block 708, the adjustment calculation circuitry 206 multiplies the digital demographic impressions by the one or more device adjustment factors. Additionally, at block 708, the adjustment calculation circuitry 206 normalizes the digital device-demographic impressions such that the digital device-demographic impressions add up to the total of the current raw digital census impressions for each telecast/quarter hour. In some examples, at block 708, the example adjustment calculation circuitry 206 generates two sets of digital device-demographic impressions, one national and one local.

In the illustrated example of FIG. 7, at block 710, the example adjustment calculation circuitry 206 calculates digital device-demographic impressions with co-viewing by applying the one or more co-viewing factors to the digital device-demographic impressions. For example, at block 710, the adjustment calculation circuitry 206 performs a dot product between a co-viewing factor matrix and the digital device-demographic impressions to determine national and local co-viewing impressions for respective secondary demographics. Additionally, at block 710, the adjustment calculation circuitry 206 adds the national co-viewing impressions to the secondary demographics of the national digital device-demographic impressions and adds the local co-viewing impressions to the secondary demographics of the local digital device-demographic impressions.

In the illustrated example of FIG. 7, at block 712, the example scaling calculation circuitry 208 (FIG. 2) calculates scaled digital device-demographic impressions with co-viewing by scaling the digital device-demographic impressions with co-viewing. For example, at block 712, the scaling calculation circuitry 208 determines one or more national scaling factors by determining a ratio of national digital device-demographic impressions with co-viewing to rounded national digital device-demographic impressions with co-viewing. The rounded national digital device-demographic impressions are determined by the rounding calculation circuitry 210 (FIG. 2). Additionally, at block 712, the scaling calculation circuitry 208 scales the national digital device-demographic impressions with co-viewing by multiplying the digital device-demographic impressions with co-viewing by the one or more national scaling factors.

In the illustrated example of FIG. 7, at block 714, the example rounding calculation circuitry 210 calculates rounded scaled digital device-demographic impressions with co-viewing by rounding the scaled national digital device-demographic impressions with co-viewing to the nearest integer. Additionally, at block 714, the example rounding calculation circuitry 210 calculates rounded scaled digital device-demographic impressions with co-viewing by rounding local digital device-demographic impressions with co-viewing to the nearest integer. After block 714 the example machine readable instructions and/or operations 700 terminate.

FIG. 8 is a block diagram of an example processor platform 800 structured to execute and/or instantiate the machine readable instructions and/or operations of FIGS. 6 and/or 7 to implement the dTVR control circuitry 200 of FIG. 1A, 1B, and/or 2. The processor platform 800 can be, for example, a server, a personal computer, a workstation, a self-learning machine (e.g., a neural network), an Internet appliance, or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 812 may be implemented by one or more a semiconductor based (e.g., silicon based) devices. In this example, the processor circuitry 812 implements the example data interface circuitry 202, the example factor generation circuitry 204, the example adjustment calculation circuitry 206, the example scaling calculation circuitry 208, the example rounding calculation circuitry 210, and/or more generally, the example dTVR control circuitry 200 of FIGS. 1A, 1B, and/or 2.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices, and DVD drives.

In the illustrated example of FIG. 8, one or more of the local memory 813, the volatile memory 814, the non-volatile memory 816, and/or the mass storage devices 828 implement the memory 212 of FIG. 2. The machine executable instructions 832, which may be implemented by the machine readable instructions and/or operations 600 of FIG. 6 and/or the machine readable instructions and/or operations 700 of FIG. 7, may be stored in the mass storage device 828, in the volatile memory 814, in the non-volatile memory 816, and/or on a removable non-transitory computer readable storage medium such as a CD or DVD.

FIG. 9 is a block diagram of an example implementation of the processor circuitry 812 of FIG. 8. In this example, the processor circuitry 812 of FIG. 8 is implemented by a microprocessor 900. For example, the microprocessor 900 may implement multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 6 and/or 7.

The cores 902 may communicate by an example first bus 904. In some examples, the first bus 904 may implement a communication bus to effectuate communication associated with one(s) of the cores 902. For example, the first bus 904 may implement at least one of an Inter-Integrated Circuit (I2C) bus, a Serial Peripheral Interface (SPI) bus, a PCI bus, or a PCIe bus. Additionally or alternatively, the first bus 904 may implement any other type of computing or electrical bus. The cores 902 may obtain data, instructions, and/or signals from one or more external devices by example interface circuitry 906. The cores 902 may output data, instructions, and/or signals to the one or more external devices by the interface circuitry 906.

Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the L1 cache 920, and an example second bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The second bus 922 may implement at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The microprocessor 900 may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the processor circuitry 812 of FIG. 8. In this example, the processor circuitry 812 is implemented by FPGA circuitry 1000. The FPGA circuitry 1000 can be used, for example, to perform operations that could otherwise be performed by the example microprocessor 900 of FIG. 9 executing corresponding machine readable instructions and/or operations. However, once configured, the FPGA circuitry 1000 instantiates the machine readable instructions and/or operations in hardware and, thus, can often execute the operations faster than they could be performed by a general purpose microprocessor executing the corresponding software.

More specifically, in contrast to the microprocessor 900 of FIG. 9 described above (which is a general purpose device that may be programmed to execute some or all of the machine readable instructions and/or operations represented by the flowcharts of FIGS. 6 and/or 7 but whose interconnections and logic circuitry are fixed once fabricated), the FPGA circuitry 1000 of the example of FIG. 10 includes interconnections and logic circuitry that may be configured and/or interconnected in different ways after fabrication to instantiate, for example, some or all of the machine readable instructions and/or operations represented by the flowcharts of FIGS. 6 and/or 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the software represented by the flowcharts of FIGS. 6 and/or 7. As such, the FPGA circuitry 1000 may be structured to effectively instantiate some or all of the machine readable instructions and/or operations of the flowcharts of FIGS. 6 and/or 7 as dedicated logic circuits to perform the operations corresponding to those software instructions in a dedicated manner analogous to an ASIC. Therefore, the FPGA circuitry 1000 may perform the operations corresponding to the some or all of the machine readable instructions and/or operations of FIGS. 6 and/or 7 faster than the general purpose microprocessor can execute the same.

In the example of FIG. 10, the FPGA circuitry 1000 is structured to be programmed (and/or reprogrammed one or more times) by an end user by a hardware description language (HDL) such as Verilog. The FPGA circuitry 1000 of FIG. 10, includes example input/output (I/O) circuitry 1002 to obtain and/or output data to/from example configuration circuitry 1004 and/or external hardware (e.g., external hardware circuitry) 1006. For example, the configuration circuitry 1004 may implement interface circuitry that may obtain machine readable instructions and/or operations to configure the FPGA circuitry 1000, or portion(s) thereof. In some such examples, the configuration circuitry 1004 may obtain the machine readable instructions and/or operations from a user, a machine (e.g., hardware circuitry (e.g., programmed or dedicated circuitry) that may implement an Artificial Intelligence/Machine Learning (AI/ML) model to generate the instructions and/or operations), etc. In some examples, the external hardware 1006 may implement the microprocessor 900 of FIG. 9. The FPGA circuitry 1000 also includes an array of example logic gate circuitry 1008, a plurality of example configurable interconnections 1010, and example storage circuitry 1012. The logic gate circuitry 1008 and interconnections 1010 are configurable to instantiate one or more operations that may correspond to at least some of the machine readable instructions and/or operations of FIGS. 6 and/or 7 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 812 of FIG. 8, many other approaches are contemplated. For example, as mentioned above, modern FPGA circuitry may include an on-board CPU, such as one or more of the example CPU 1020 of FIG. 10. Therefore, the processor circuitry 812 of FIG. 8 may additionally be implemented by combining the example microprocessor 900 of FIG. 9 and the example FPGA circuitry 1000 of FIG. 10. In some such hybrid examples, a first portion of the machine readable instructions and/or operations represented by the flowcharts of FIGS. 6 and/or 7 may be executed by one or more of the cores 902 of FIG. 9 and a second portion of the machine readable instructions and/or operations represented by the flowcharts of FIGS. 6 and/or 7 may be executed by the FPGA circuitry 1000 of FIG. 10.

In some examples, the processor circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the processor circuitry 812 of FIG. 8, which may be in one or more packages. For example, the XPU may include a CPU in one package, a DSP in another package, a GPU in yet another package, and an FPGA in still yet another package.

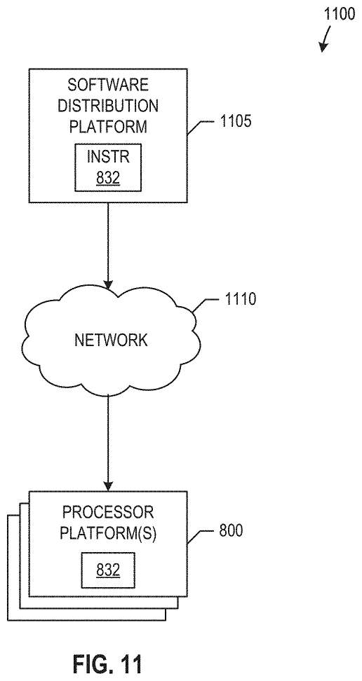

A block diagram illustrating an example software distribution platform 1105 to distribute software such as the example machine readable instructions 832 of FIG. 8 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions 832 of FIG. 8, as described above. The one or more servers of the example software distribution platform 1105 are in communication with a network 1110, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or by a third-party payment entity. The servers enable purchasers and/or licensors to download the machine readable instructions 832 from the software distribution platform 1105. For example, the software, which may correspond to the example machine readable instructions 832 of FIG. 8, may be downloaded to the example processor platform 800, which is to execute the machine readable instructions 832 to implement the dTVR control circuitry 200 of FIGS. 1A, 1B, and/or 2. In some example, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices.

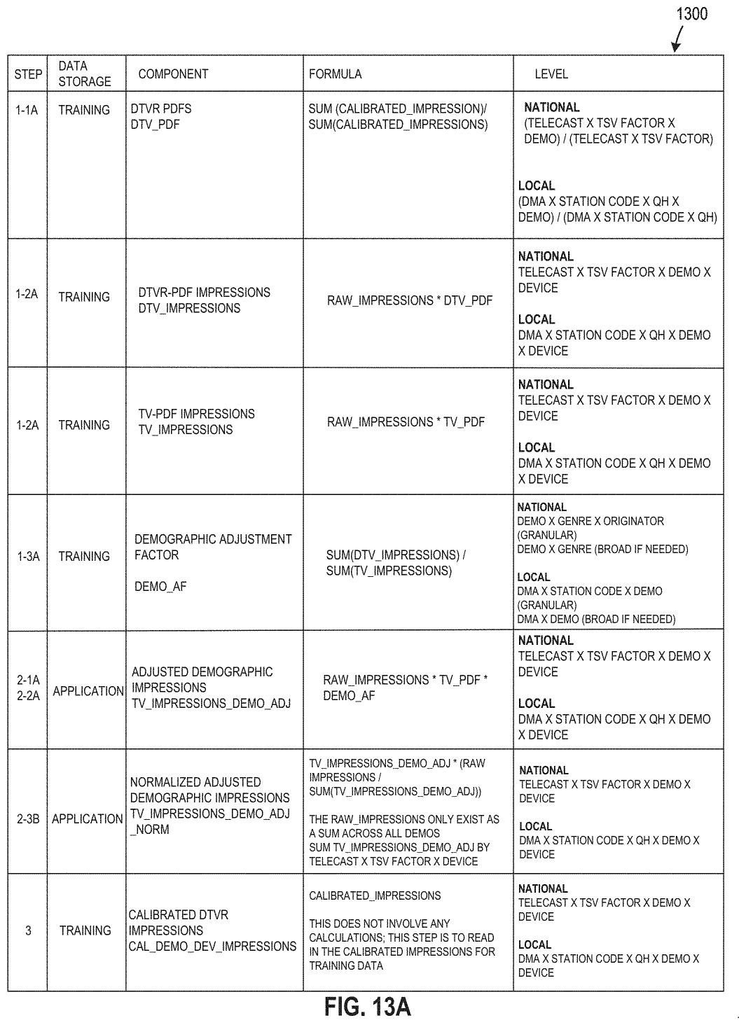

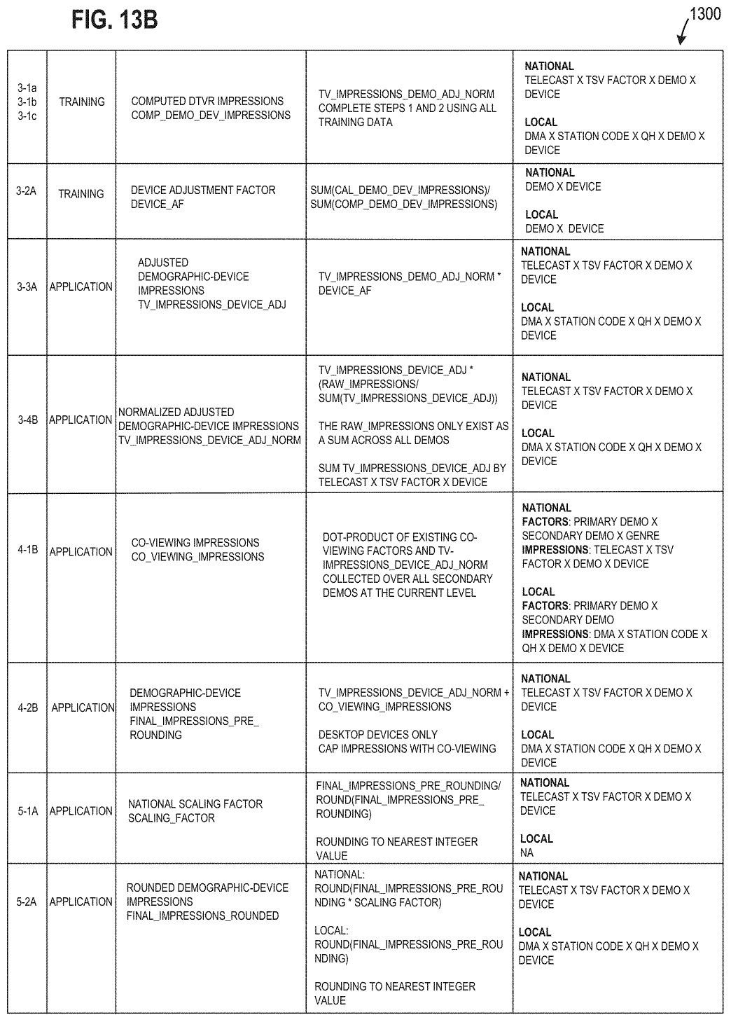

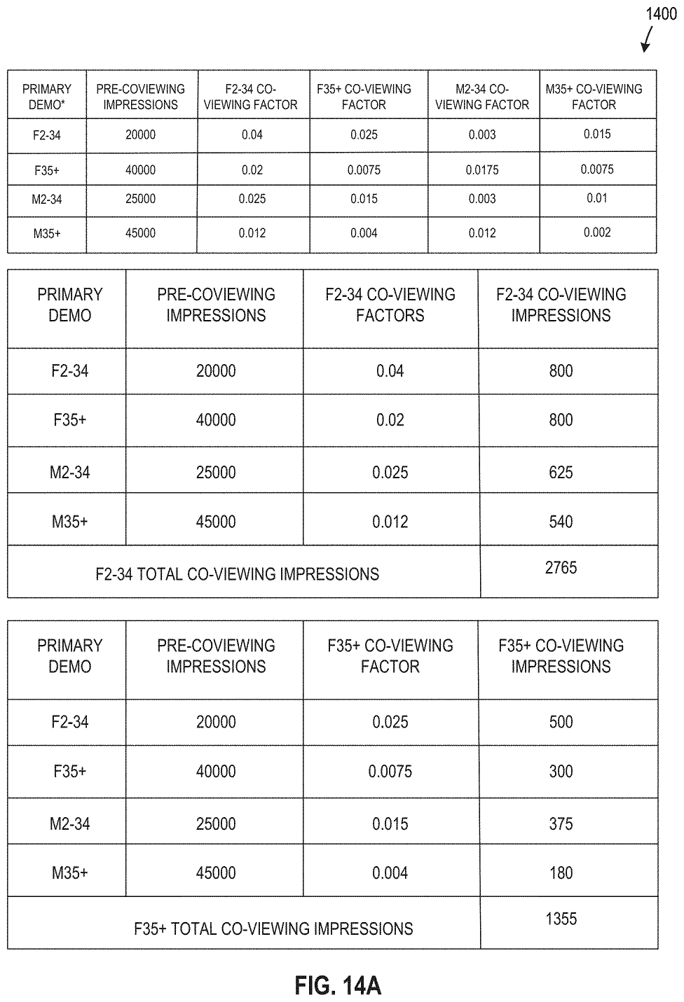

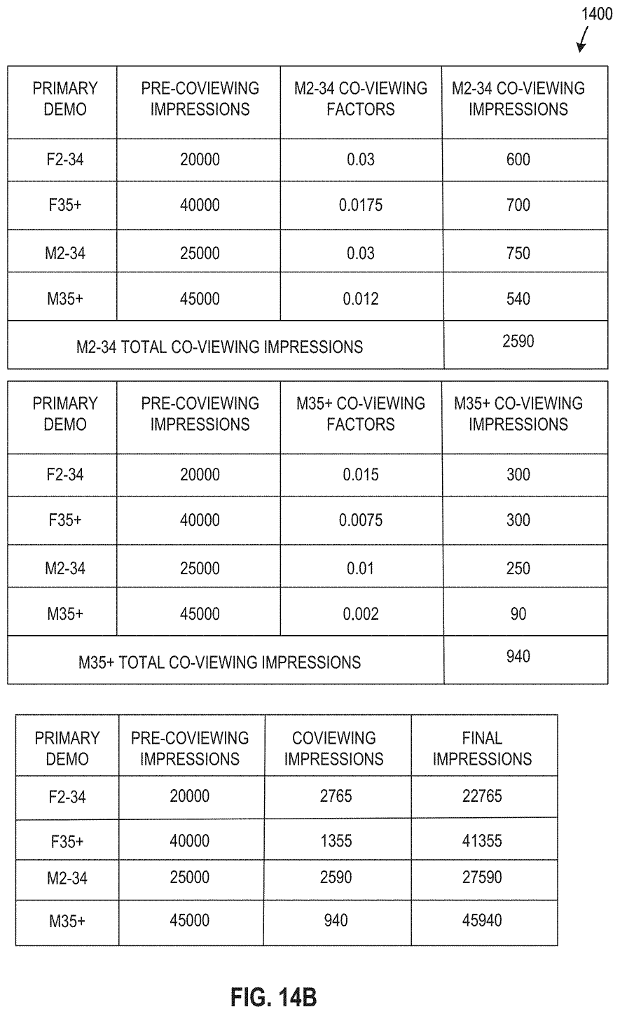

FIGS. 13A and 13B illustrate an example table 1300 describing example components set forth herein. FIGS. 14A and 14B are example tables 1400 describing example co-viewing impressions.

From the foregoing, it will be appreciated that example systems, methods, apparatus, and articles of manufacture have been disclosed that assign demographic distribution data to digital TV ratings. Example systems, methods, apparatus, and articles of manufacture disclosed herein provide a solution to the technical problem presented by the increased adoption of non-linear media and increased trends in individual privacy on networks. The disclosed systems, methods, apparatus, and articles of manufacture improve the efficiency of using a computing device by improving the accuracy of programmed processor circuitry in generating more accurate audience metrics.

For example, disclosed systems, methods, apparatus, and articles of manufacture improve the accuracy of programmed processor circuitry in generating more accurate audience metrics by accounting for differences between demographic distributions for linear TV and demographic distributions for digital TV. Such differences between demographic distributions for linear TV and demographic distributions for digital TV are due to, in part, the technical means by which linear TV and digital TV are served to end users. Examples disclosed herein calculate one or more demographic adjustment factors and/or one or more device adjustment factors to account for such differences between linear TV and digital TV thereby improving the accuracy of programmed processor circuitry in generating more accurate audience metrics by accounting for differences between demographic distributions for linear TV and demographic distributions for digital TV. The disclosed systems, methods, apparatus, and articles of manufacture are accordingly directed to one or more improvement(s) in the operation of a machine such as a computer or other electronic and/or mechanical device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to assign demographics to current raw digital census impressions, the apparatus comprising:
factor generation circuitry to:
calculate a demographic adjustment factor based on digital probability distribution function (PDF) (digital-PDF) impressions and linear PDF (linear-PDF) impressions; and
calculate a device adjustment factor based on historical calibrated demographic digital impressions and historical computed demographic digital impressions; and
adjustment calculation circuitry to:
determine digital demographic impressions by applying the demographic adjustment factor to the current raw digital census impressions; and
determine digital device-demographic impressions by applying the device adjustment factor to the digital demographic impressions.

2. The apparatus of claim 1, wherein the factor generation circuitry is to:
determine the digital-PDF impressions by applying a historical digital television (TV) PDF to historical raw digital census impressions;
determine the linear-PDF impressions by applying a historical linear TV PDF to the historical raw digital census impressions; and
calculate the demographic adjustment factor as a ratio between the digital-PDF impressions and the linear-PDF impressions.

3. The apparatus of claim 2, wherein the linear TV PDF is based on impressions of a home television viewing panel.

4. The apparatus of claim 1, wherein the factor generation circuitry is to:
determine the linear-PDF impressions by applying a historical linear TV PDF to historical raw digital census impressions;
apply the demographic adjustment factor to the linear-PDF impressions;
normalize the linear-PDF impressions to determine the historical computed demographic digital impressions; and
calculate the device adjustment factor as a ratio between the historical calibrated demographic digital impressions and the historical computed demographic digital impressions.

5. The apparatus of claim 1, wherein the adjustment calculation circuitry is to:
normalize the digital demographic impressions; and
normalize the digital device-demographic impressions.

6. The apparatus of claim 1, wherein the historical calibrated demographic digital impressions include a number of digitally viewed minutes of all TV telecasts after aggregated demographics have been assigned by a database proprietor and calibration has been applied to correct for at least one of unknown gender, misattribution for device sharing, non-coverage, or co-viewing.

7. The apparatus of claim 1, wherein the current raw digital census impressions include a number of digitally viewed minutes of TV telecasts that returned a ping from a digital device.

8. A non-transitory computer readable medium comprising instructions that, when executed, cause processor circuitry to at least:
calculate a demographic adjustment factor based on digital probability distribution function (PDF) (digital-PDF) impressions and linear PDF (linear-PDF) impressions;
calculate a device adjustment factor based on historical calibrated demographic digital impressions and historical computed demographic digital impressions;
determine digital demographic impressions by applying the demographic adjustment factor to the current raw digital census impressions; and
determine digital device-demographic impressions by applying the device adjustment factor to the digital demographic impressions.

9. The non-transitory computer readable medium of claim 8, wherein the instructions, when executed, cause the processor circuitry to:
determine the digital-PDF impressions by applying a historical digital television (TV) PDF to historical raw digital census impressions;
determine the linear-PDF impressions by applying a historical linear TV PDF to the historical raw digital census impressions; and
calculate the demographic adjustment factor as a ratio between the digital-PDF impressions and the linear-PDF impressions.

10. The non-transitory computer readable medium of claim 9, wherein the linear TV PDF is based on impressions of a home television viewing panel.

11. The non-transitory computer readable medium of claim 8, wherein the instructions, when executed, cause the processor circuitry to:
determine the linear-PDF impressions by applying a historical linear TV PDF to historical raw digital census impressions;
apply the demographic adjustment factor to the linear-PDF impressions;
normalize the linear-PDF impressions to determine the historical computed demographic digital impressions; and
calculate the device adjustment factor as a ratio between the historical calibrated demographic digital impressions and the historical computed demographic digital impressions.

12. The non-transitory computer readable medium of claim 8, wherein the instructions, when executed, cause the processor circuitry to:
normalize the digital demographic impressions; and
normalize the digital device-demographic impressions.

13. The non-transitory computer readable medium of claim 8, wherein the historical calibrated demographic digital impressions include a number of digitally viewed minutes of all TV telecasts after aggregated demographics have been assigned by a database proprietor and calibration has been applied to correct for at least one of unknown gender, misattribution for device sharing, non-coverage, or co-viewing.

14. The non-transitory computer readable medium of claim 8, wherein the current raw digital census impressions include a number of digitally viewed minutes of TV telecasts that returned a ping from a digital device.

15. An apparatus to assign demographics to current raw digital census impressions, the apparatus comprising:
means for generating one or more adjustment factors to:
calculate a demographic adjustment factor based on digital probability distribution function (PDF) (digital-PDF) impressions and linear PDF (linear-PDF) impressions; and
calculate a device adjustment factor based on historical calibrated demographic digital impressions and historical computed demographic digital impressions; and
means for adjusting to:
determine digital demographic impressions by applying the demographic adjustment factor to the current raw digital census impressions; and
determine digital device-demographic impressions by applying the device adjustment factor to the digital demographic impressions.

16. The apparatus of claim 15, wherein the means for generating one or more adjustment factors is to:
determine the digital-PDF impressions by applying a historical digital television (TV) PDF to historical raw digital census impressions;
determine the linear-PDF impressions by applying a historical linear TV PDF to the historical raw digital census impressions; and
calculate the demographic adjustment factor as a ratio between the digital-PDF impressions and the linear-PDF impressions.

17. The apparatus of claim 16, wherein the linear TV PDF is based on impressions of a home television viewing panel.

18. The apparatus of claim 15, wherein the means for generating one or more adjustment factors is to:
determine the linear-PDF impressions by applying a historical linear TV PDF to historical raw digital census impressions;
apply the demographic adjustment factor to the linear-PDF impressions;
normalize the linear-PDF impressions to determine the historical computed demographic digital impressions; and
calculate the device adjustment factor as a ratio between the historical calibrated demographic digital impressions and the historical computed demographic digital impressions.

19. The apparatus of claim 15, wherein the means for adjusting is to:
normalize the digital demographic impressions; and
normalize the digital device-demographic impressions.

20. The apparatus of claim 15, wherein the historical calibrated demographic digital impressions include a number of digitally viewed minutes of all TV telecasts after aggregated demographics have been assigned by a database proprietor and calibration has been applied to correct for at least one of unknown gender, misattribution for device sharing, non-coverage, or co-viewing.
